(19) United States
(12) Patent Application Publication
(10) Pub. No.: US 2026/0343423 A1
(43) Pub. Date: Oct. 29, 2026

(54) TECHNIQUES FOR TRANSMIT POWER CONTROL ADAPTATION IN ANTENNA SWITCHING

(71) Applicant: QUALCOMM Incorporated, San Diego, CA (US)

(72) Inventors: Xinyu WANG, Beijing (CN); Yuyu YAN, Beijing (CN); Yong LI, San Diego, CA (US); Jianming ZHU, Acton, MA (US); Enoch Shiao-Kuang LU, San Diego, CA (US); Jie MAO, Beijing (CN); Ling XIE, Beijing (CN); Zhanyi LIU, Beijing (CN); Liang HONG, Beijing (CN); Tom CHIN, San Diego, CA (US); Dinesh Kumar DEVINENI, San Diego, CA (US); Ashok MANTRAVADI, San Diego, CA (US)

(21) Appl. No.: 19/117,940

(22) PCT Filed: Feb. 15, 2023
(86) PCT No.: PCT/CN2023/076052

§ 371 Date: Apr. 2, 2025

(30) Foreign Application Priority Data
Nov. 24, 2022 (WO) PCT/CN2022/133893

(51) Int. Cl. H04W 52/24; H04B 7/06; H04W 52/14; H04W 52/42

(52) U.S. Cl. CPC H04W 52/242; H04B 7/061; H04W 52/146; H04W 52/42

(57) ABSTRACT

Methods, systems, and devices for wireless communications are described in which uplink transmit power may be adjusted as part of an antenna switching procedure. A user equipment (UE) may receive one or more transmit power control (TPC) commands for an uplink transmit power for an uplink transmission via a first antenna, the TPC commands indicating a decrease in an uplink transmit power. The UE may determine, subsequent to the receiving the TPC commands, to switch from the first antenna to a second antenna for one or more communications, and determine a pathloss discrepancy based on one or more pathloss measurements and the one or more TPC commands associated with the first antenna. The UE may adjust, based on the pathloss discrepancy, an accumulated TPC value associated with a transmit power control procedure for communications via the second antenna.

### CROSS-REFERENCE

The present Application is a 371 national stage filing of International PCT Application No. PCT/CN2023/076052 by WANG et al. entitled “TECHNIQUES FOR TRANSMIT POWER CONTROL ADAPTATION IN ANTENNA SWITCHING,” filed Feb. 15, 2023; and claims priority to International PCT Patent Application No. PCT/CN2022/133893 by WANG et al., entitled “TECHNIQUES FOR TRANSMIT POWER CONTROL ADAPTATION IN ANTENNA SWITCHING,” filed Nov. 24, 2022, each of which is assigned to the assignee hereof, and each of which is expressly incorporated by reference in its entirety herein.

### FIELD OF TECHNOLOGY

The following relates to wireless communications, including techniques for transmit power control adaptation in antenna switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network entities, each simultaneously supporting communication for multiple communication devices, which may be otherwise known as user equipment (UE). In some wireless communications systems, a UE may communicate with a base station using uplink and downlink communications, in which different antennas and associated components (e.g., amplifiers, phase shifters, etc.) of multiple transmit/receive chains may be used for uplink transmissions and for downlink receptions. In such systems, selection of one or more antenna ports associated with multiple transmit/receive chains allows for enhanced communications efficiency from increased diversity in antenna port selection, which allows for selection of an antenna port having more favorable channel metrics. Enhanced techniques for switching of antenna ports of multiple available antenna ports may help to further enhance communications efficiency.

### SUMMARY

The described techniques relate to improved methods, systems, devices, and apparatuses that support techniques for transmit power control (TPC) adaptation in antenna switching. For example, the described techniques provide for adjustment of an accumulated TPC (ATPC) at a user equipment (UE), where an uplink transmit power may be determined based on an adjusted ATPC. In some aspects, the ATPC may be adjusted in an antenna switch diversity (AsDIV) procedure in cases where a pathloss discrepancy exceeds a threshold value. In accordance with various techniques discussed herein, the pathloss discrepancy may be calculated by adding negative TPC commands received at the UE within a time period before an antenna switch. If the pathloss discrepancy exceeds the threshold value, the ATPC may be adjusted to provide a transmit power that is more likely to provide reliable communications subsequent to the antenna switch. In some cases, the adjusted ATPC to be used after the antenna switch may be selected from a set of candidate ATPC values. The UE may record ATPC candidates and associated pathloss values during regular channel measurement occasions when the ATPC value is larger than a threshold. The pathloss discrepancy may be reset when there is a positive TPC from the network, when the ATPC is unchanged for a time interval with multiple uplink transmissions (e.g., indicating that there is no pathloss discrepancy), or a change in a cell ID of a serving cell.

A method for wireless communications at a user equipment (UE) is described. The method may include receiving one or more transmit power control commands for an uplink transmit power for an uplink transmission via at least a first antenna, the one or more transmit power control commands indicating a decrease in an uplink transmit power, where the uplink transmit power for the uplink transmission is based on an accumulation of a set of multiple transmit power control commands, determining, subsequent to the receiving the one or more transmit power control commands, to switch from the first antenna to a second antenna for one or more communications, determining a pathloss discrepancy based on one or more pathloss measurements and the one or more transmit power control commands associated with the first antenna, and adjusting, based on the pathloss discrepancy, an accumulated transmit power control value associated with a transmit power control procedure for communications via the second antenna.

An apparatus for wireless communications at a UE is described. The apparatus may include a processor, memory coupled with the processor, and instructions stored in the memory. The instructions may be executable by the processor to cause the apparatus to receive one or more transmit power control commands for an uplink transmit power for an uplink transmission via at least a first antenna, the one or more transmit power control commands indicating a decrease in an uplink transmit power, where the uplink transmit power for the uplink transmission is based on an accumulation of a set of multiple transmit power control commands, determine, subsequent to the receiving the one or more transmit power control commands, to switch from the first antenna to a second antenna for one or more communications, determine a pathloss discrepancy based on one or more pathloss measurements and the one or more transmit power control commands associated with the first antenna, and adjust, based at least in part on the pathloss discrepancy, an accumulated transmit power control value associated with a transmit power control procedure for communications via the second antenna.

Another apparatus for wireless communications at a UE is described. The apparatus may include means for receiving one or more transmit power control commands for an uplink transmit power for an uplink transmission via at least a first antenna, the one or more transmit power control commands indicating a decrease in an uplink transmit power, where the uplink transmit power for the uplink transmission is based on an accumulation of a set of multiple transmit power control commands, means for determining, subsequent to the receiving the one or more transmit power control commands, to switch from the first antenna to a second antenna for one or more communications, means for determining a pathloss discrepancy based on one or more pathloss measurements and the one or more transmit power control commands associated with the first antenna, and means for adjusting, based on the pathloss discrepancy, an accumulated transmit power control value associated with a transmit power control procedure for communications via the second antenna.

A non-transitory computer-readable medium storing code for wireless communications at a UE is described. The code may include instructions executable by a processor to receive one or more transmit power control commands for an uplink transmit power for an uplink transmission via at least a first antenna, the one or more transmit power control commands indicating a decrease in an uplink transmit power, where the uplink transmit power for the uplink transmission is based on an accumulation of a set of multiple transmit power control commands, determine, subsequent to the receiving the one or more transmit power control commands, to switch from the first antenna to a second antenna for one or more communications, determine a pathloss discrepancy based on one or more pathloss measurements and the one or more transmit power control commands associated with the first antenna, and adjust, based at least in part on the pathloss discrepancy, an accumulated transmit power control value associated with a transmit power control procedure for communications via the second antenna.

In some examples of the method, apparatuses, and non-transitory computer-readable medium described herein, the determining the pathloss discrepancy may include operations, features, means, or instructions for determining that two or more transmit power control commands that indicate a decrease in the uplink transmit power are received within a predetermined time interval. In some examples of the method, apparatuses, and non-transitory computer-readable medium described herein, the adjusting the accumulated transmit power control value may include operations, features, means, or instructions for selecting a first accumulated transmit power control value from a set of candidate accumulated transmit power control values based on a pathloss associated with each of the candidate accumulated transmit power control values and a pathloss associated with the second antenna, and adjusting the accumulated transmit power control value based on the first accumulated transmit power control value.

Some examples of the method, apparatuses, and non-transitory computer-readable medium described herein may further include operations, features, means, or instructions for identifying, for at least one measurement instance prior to the switch from the first antenna to a second antenna, a pathloss associated with the first antenna and storing an accumulated transmit power control value and the identified pathloss as a candidate accumulated transmit power control value of the set of candidate accumulated transmit power control values. Some examples of the method, apparatuses, and non-transitory computer-readable medium described herein may further include operations, features, means, or instructions for determining, subsequent to the identifying, to store the accumulated transmit power control value and the identified pathloss based on the associated accumulated transmit power control value being larger than a prior accumulated transmit power control value and a threshold value, and the associated accumulated transmit power control value exceeding the threshold value and being unchanged for at least a predetermined time interval in which one or more uplink communications may be transmitted. Some examples of the method, apparatuses, and non-transitory computer-readable medium described herein may further include operations, features, means, or instructions for resetting the set of candidate accumulated transmit power control values responsive to a cell identification change of a serving cell for uplink transmissions via the first antenna or the second antenna.

Some examples of the method, apparatuses, and non-transitory computer-readable medium described herein may further include operations, features, means, or instructions for determining a first value that corresponds to difference between a first pathloss measurement associated with the first antenna and a second pathloss measurement associated with the second antenna; computing a second value as a product of the first value and at least one scaling factor; and adding the second value to the accumulated transmit power control value. Some examples of the method, apparatuses, and non-transitory computer-readable medium described herein may further include operations, features, means, or instructions for resetting the pathloss discrepancy based at least in part on one or more of a receipt of two or more transmit power control commands that indicate an increase in the uplink transmit power within a time window, the accumulated transmit power control value being unchanged for a predetermined time interval in which one or more uplink communications are transmitted, or a change in a cell identification of a serving cell, where the time window starts upon receipt of a first transmit power control command that indicates an increase in the uplink transmit power, and the time window is reset and suspended upon expiration of the time window or receipt of a second transmit power control command that indicates a decrease in the uplink transmit power.

In some examples of the method, apparatuses, and non-transitory computer-readable medium described herein, the pathloss discrepancy may be based on an accumulated number of transmit power control commands that indicate a decrease in the uplink transmit power. Some examples of the method, apparatuses, and non-transitory computer-readable medium described herein may further include operations, features, means, or instructions for resetting the pathloss discrepancy based on one or more of a receipt of a transmit power control command that indicates an increase in the uplink transmit power, the accumulated transmit power control value being unchanged for a predetermined time interval in which one or more uplink communications are transmitted, or a change in a cell identification of a serving cell. Some examples of the method, apparatuses, and non-transitory computer-readable medium described herein may further include operations, features, means, or instructions for resetting the pathloss discrepancy based at least in part on one or more of a receipt of two or more TPC commands that indicate an increase in the uplink transmit power within a time window, the ATPC value being unchanged for a predetermined time interval in which one or more uplink communications are transmitted, or a change in a cell identification of a serving cell. In some cases, the time window starts upon receipt of a first TPC command that indicates an increase in the uplink transmit power, and the time window is reset and suspended upon expiration of the time window or receipt of a second TPC command that indicates the decrease in the uplink transmit power

In some examples of the method, apparatuses, and non-transitory computer-readable medium described herein, the adjusting the accumulated transmit power control value may be performed responsive to the pathloss discrepancy exceeding a threshold value. In some examples of the method, apparatuses, and non-transitory computer-readable medium described herein, the adjusting the accumulated transmit power control value may be based on a first candidate accumulated transmit power control value from a set of candidate accumulated transmit power control values that has a closest associated pathloss to an identified pathloss for the second antenna.

In some examples of the method, apparatuses, and non-transitory computer-readable medium described herein, the set of candidate accumulated transmit power control values include at least the first candidate accumulated transmit power control value associated with a first pathloss and a second candidate accumulated transmit power control value associated with a second pathloss and the method, apparatuses, and non-transitory computer-readable medium may include further operations, features, means, or instructions for determining that a difference between the identified pathloss for the second antenna and the first pathloss has a same value as a difference between the identified pathloss for the second antenna and the second pathloss, and selecting the first candidate accumulated transmit power control value responsive to the first candidate accumulated transmit power control value having a higher value than the second candidate accumulated transmit power control value.

In some examples of the method, apparatuses, and non-transitory computer-readable medium described herein, the adjusting the accumulated transmit power control value may be performed responsive to the first candidate accumulated transmit power control value having a higher value than a current accumulated transmit power control value subsequent to the switch from the first antenna to the second antenna. In some examples of the method, apparatuses, and non-transitory computer-readable medium described herein, the determining the pathloss discrepancy may be responsive to a change in an estimated pathloss subsequent to the switch to the second antenna exceeding an amount of the adjustment in the accumulated transmit power control value.

In some examples of the method, apparatuses, and non-transitory computer-readable medium described herein, the determining the pathloss discrepancy may include operations, features, means, or instructions for scaling the change in the estimated pathloss subsequent to the switch to the second antenna according to a scaling factor to determine a scaled estimated pathloss difference, and comparing the scaled estimated pathloss difference to the amount of the adjustment in the accumulated transmit power control value, and where the adjusting is performed responsive to the scaled estimated pathloss difference exceeding the amount of the adjustment in the accumulated transmit power control value. Some examples of the method, apparatuses, and non-transitory computer-readable medium described herein may further include operations, features, means, or instructions for resetting a value associated with the pathloss discrepancy responsive to the adjusting the accumulated transmit power control value.

### BRIEF DESCRIPTION OF THE DRAWINGS

FIG. 1 illustrates an example of a wireless communications system that supports techniques for TPC adaptation in antenna switching in accordance with one or more aspects of the present disclosure.

FIG. 2 illustrates an example of a wireless communications system that supports techniques for TPC adaptation in antenna switching in accordance with one or more aspects of the present disclosure.

FIG. 3 illustrates examples of pathloss and ATPC versus time that support techniques for TPC adaptation in antenna switching in accordance with one or more aspects of the present disclosure.

FIGS. 4 and 5 illustrate flowcharts showing methods that support techniques for TPC adaptation in antenna switching in accordance with one or more aspects of the present disclosure.

FIG. 6 illustrates another example of pathloss and ATPC versus time that supports techniques for TPC adaptation in antenna switching in accordance with one or more aspects of the present disclosure.

FIGS. 7 and 8 illustrate flowcharts showing additional methods that support techniques for TPC adaptation in antenna switching in accordance with one or more aspects of the present disclosure.

FIGS. 9 and 10 illustrate block diagrams of devices that support techniques for TPC adaptation in antenna switching in accordance with one or more aspects of the present disclosure.

FIG. 11 illustrates a block diagram of a communications manager that supports techniques for TPC adaptation in antenna switching in accordance with one or more aspects of the present disclosure.

FIG. 12 illustrates a diagram of a system including a device that supports techniques for TPC adaptation in antenna switching in accordance with one or more aspects of the present disclosure.

FIGS. 13 through 16 illustrate flowcharts showing methods that support techniques for TPC adaptation in antenna switching in accordance with one or more aspects of the present disclosure.

### DETAILED DESCRIPTION

In some wireless communications systems, a user equipment (UE) may use antenna switch diversity (AsDIV) as one technique to enhance transmission and reception performance at the UE. This technique uses measured channel metrics, such as reference signal received power (RSRP) of a reference signal measured at each antenna port of a set of antenna ports, and maximum transmit power (e.g., a maximum transmit power limit (MTPL)) available for each antenna port, to select which of multiple different antenna ports is to be used as a receive antenna port and transmit antenna port. When performing antenna switching in AsDIV procedures, current techniques provide that a transmit power after the antenna switch is based on accumulated transmit power control (TPC) commands, and an estimated pathloss of the new antenna. However, in some cases, TPC commands may diverge from actual pathloss measurements. For example, a UE may receive a negative TPC, that indicates transmit power is to be reduced, but the pathloss for the antenna at the UE may be increasing. Such situations may occur, for example, in frequency division duplexing (FDD) deployments where channel reciprocity may not hold between uplink and downlink channels. In such cases, after an antenna switch, a new uplink transmit power may be determined based on a reduced pathloss for the new antenna and the current value of the accumulated TPC (ATPC). In such a case, the reduced value of the ATPC may result in an uplink transmit power that is reduced too far and may result in a relatively high block error rate (BLER). Thus, techniques to adapt an uplink transmit power subsequent to an antenna switching procedure in such situations may help to enhance the reliability and efficiency of wireless communications.

In accordance with various techniques discussed herein, an ATPC value at a UE may be adjusted after AsDIV antenna switching in cases where a pathloss discrepancy exceeds a threshold value. In some cases, the pathloss discrepancy may be calculated by adding all negative TPCs received at the UE within a time period before the antenna switch (e.g., a predetermined time period, or a sliding window of a predetermined length). If the pathloss discrepancy exceeds the threshold value, the ATPC may be adjusted to provide an uplink transmit power that is more likely to provide reliable communications. In some cases, the adjusted ATPC to be used after the antenna switch is selected from a set of candidate ATPC values, where each candidate ATPC value has an associated pathloss estimate. The UE may identify a pathloss using the new antenna (e.g., based on reference signal received power (RSRP) measurements using the new antenna), and may select a candidate ATPC value with a pathloss that is closest to the identified pathloss. In the event that two ATPC candidates are identified (e.g., that each have a same difference from the estimated pathloss), the ATPC candidate with the higher adjustment may be selected. In some cases, the UE may record ATPC candidates and associated pathloss values during regular channel measurement occasions (e.g., based on CSI-RS measurements) when the ATPC value is larger than a threshold. In some cases, the pathloss discrepancy may be reset when there is a positive TPC from the network (e.g., indicating that an uplink transmit power is to be increased), when the ATPC is unchanged for a time interval with multiple uplink transmissions (e.g., indicating that there is no discrepancy), or a change in cell ID of a serving cell of the UE. In some cases, the pathloss discrepancy reset when: (1) there are two or more positive TPC commands from the network within a time interval, (2) the ATPC is unchanged for a time interval with multiple uplink transmissions (e.g., sufficient PUSCH/PUCCH slots to indicate no discrepancy), or (3) there is a change in cell ID of the serving cell of the UE. In some cases, the adjustment to the ATPC subsequent to the antenna switch is determined based on a product of the difference in measured pathloss of the different antennas, and one or more scaling factors (e.g., an RRC configured first scaling factor, α, and a mobile network operator (MNO) scaling factor), such as according to:

new_ATPC=α*PL_drop_delta*Scaling_factor+current ATPC.

Such techniques may provide additional reliability for UEs in antenna switching operations, through evaluation of multiple TPC commands and pathloss measurements that may reduce the impact of inaccurate negative TPCs that are received at the UE prior to an antenna switch. Techniques as discussed herein may thus provide for more efficient antenna management for UEs operating using antenna switching diversity techniques. Such techniques may provide for enhanced reliability of wireless connections of a UE, enhanced data throughput due to higher quality connections, enhanced user experience, and reduced power consumption due to fewer antenna switches.

Aspects of the disclosure are initially described in the context of wireless communications systems. Aspects of the disclosure are further illustrated by and described with reference to ATPC and pathloss discrepancies, apparatus diagrams, system diagrams, and flowcharts that relate to techniques for TPC adaptation in antenna switching.

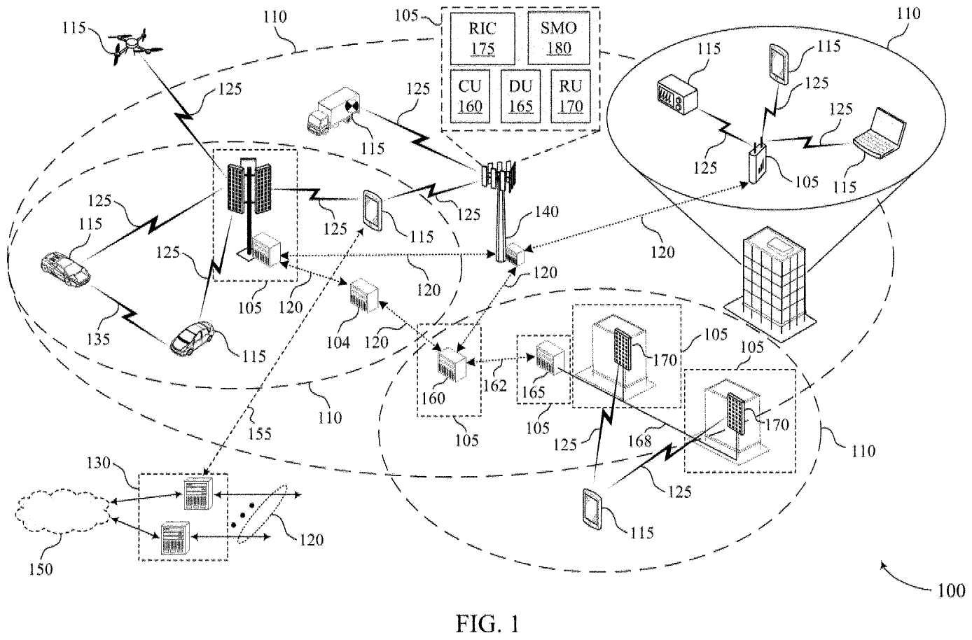

FIG. 1 illustrates an example of a wireless communications system 100 that supports techniques for TPC adaptation in antenna switching in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for TPC adaptation in antenna switching as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, a UE 115 may determine an uplink transmit power for one or more uplink transmissions based on an uplink power control procedure. Two parameters that may be used to determine the uplink transmit power include a pathloss that is measured at the UE 115 (e.g., based on reference signal measurements) and an ATPC value. In accordance with various aspects, described techniques provide for adjustment of an ATPC at the UE subsequent to an antenna switch (e.g., as part of an AsDIV procedure) in cases where a pathloss discrepancy exceeds a threshold value. In some cases, the pathloss discrepancy may be calculated by adding negative TPC commands received at the UE 115 within a time period before an antenna switch. If the pathloss discrepancy exceeds the threshold value, the ATPC may be adjusted to provide a transmit power that is more likely to provide reliable communications subsequent to the antenna switch. In some cases, the adjusted ATPC to be used after the antenna switch may be selected from a set of candidate ATPC values. Additionally, or alternatively, the UE 115 may record ATPC candidates and associated pathloss values during regular channel measurement occasions when the ATPC value is larger than a threshold. The pathloss discrepancy may be reset when there is a positive TPC from the network, when the ATPC is unchanged for a time interval with multiple uplink transmissions (e.g., indicating that there is no pathloss discrepancy), or a change in a cell ID of a serving cell.

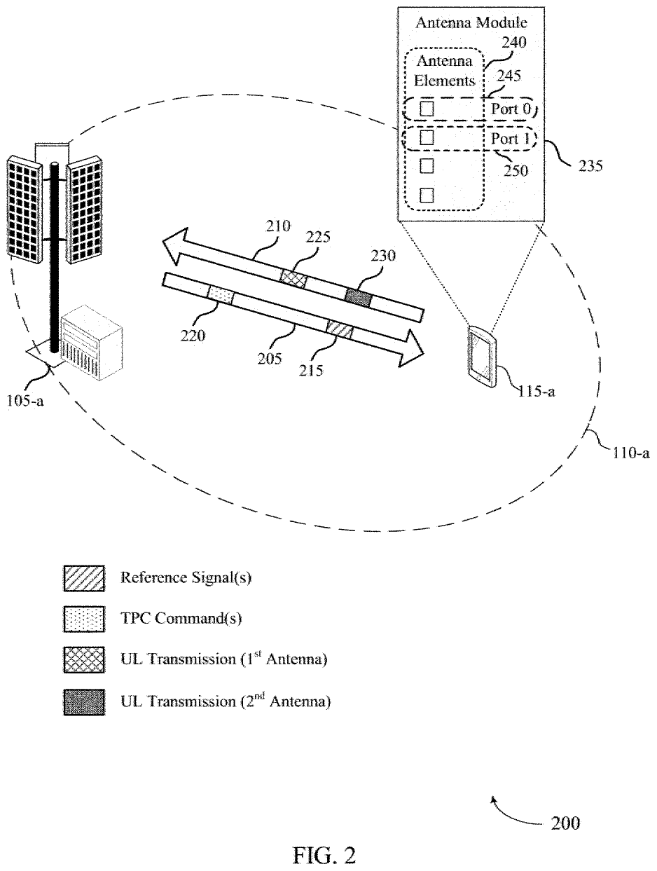

FIG. 2 illustrates an example of a wireless communications system 200 that supports techniques for TPC adaptation in antenna switching in accordance with one or more aspects of the present disclosure. In the example of FIG. 2, wireless communications system 200 may include network entity 105-a and UE 115-a, which may be examples of the corresponding devices described with respect to FIG. 1. Network entity 105-a may provide network coverage for a geographic coverage area 110-a. The network entity 105-a may transmit downlink communications 205 to the UE 115-a, and the UE 115-a may transmit uplink communications 210 to the network entity 105-a.

To support communications between network entity 105-a and UE 115-a, the network entity 105-a may transmit one or more reference signals 215 (e.g., channel state information (CSI) reference signals, synchronization signal blocks (SSBs), demodulation reference signals (DMRSs), tracking reference signals (TRSs), or any combinations thereof). The UE 115-a may measure one or more metrics of received reference signals 215 (e.g., RSRP, pathloss, signal to noise ratio (SNR), received signal strength indicator (RSSI), one or more other metrics, or any combinations thereof. The UE 115-a, in some cases, may identify one or more antennas for use in uplink and downlink communications based on one or more metrics from the measurements of the reference signals 215. For example, the UE 115-a may have an antenna system 235 that includes a number of antenna elements 240 and associated components (e.g., filters, power amplifiers, low noise amplifiers, switches, and the like), and a set of available antenna ports may include two or more antenna ports that each include one or more antenna elements 240. In the example, of FIG. 2, a first antenna port 245 (port 0) that includes a single antenna element and a second antenna port 250 (port 1) that includes a single antenna element are illustrated. While one antenna element 240 per antenna port is illustrated in FIG. 2, antenna ports may include two or more antenna elements 240 in some cases, and the set of available antenna ports may include ports with different combinations of one or more antenna elements 240. Further, in some cases, the antenna system 235 may include one or more antenna panels that may each include a number of antenna elements 240. While four antenna elements 240 are illustrated in FIG. 2, other UEs may have more or fewer antennas.

In some cases, such as implementations that use MIMO communications, antenna switch diversity (AsDIV) may be desired in which transmit antennas are selected from available receive antennas based on measurements of the receive antennas (e.g., highest receive antenna RSRPs based on measurements of reference signals 215 may be selected for uplink antennas). In some cases, AsDIV may utilize periodic measurements in order to get antenna metrics such as pathloss (e.g., based on RSRP), that may be used along with and one or more power parameters such as MTPL or a transmit power headroom to evaluate which antenna port of the set of antenna ports is likely to provide desirable uplink channel characteristics and associated performance (e.g., data transfer rates, etc.). For example, the UE 115-a may use the first antenna port 245 for uplink transmissions 225 to the network entity 105-a. The network entity 105-a may transmit one or more TPC commands 220 to the UE 115-a in accordance with an uplink transit power procedure. The TPC commands 220 may indicate an incremental increase or decrease in a computed transmit power, and the APTC value may correspond to an accumulation of multiple incremental adjustments from individual TPC commands 220 over a time period (e.g., a defined or preconfigured number of symbols before a symbol allocated for the associated uplink transmission 225 using the first antenna port 245.

As discussed above, present AsDIV techniques provide that after an antenna switch, an uplink transmit power is determined for an uplink transmission 230 using the new antenna (e.g., using second antenna port 250) based on a pathloss measurement associated with the new antenna, and a prior value of ATPC. However, in some situations TPC commands 220 transmitted to the UE 115-a may indicate that an uplink transmit power is to be reduced by the UE 115-a (e.g., the UE 115-a may receive multiple negative TPC commands that reduce the ATPC value used for uplink transmit power calculations). Such negative TPC commands 220 may be received at the UE 115-a while pathloss measurements may show that pathloss is increasing. In such cases, the new uplink transmit power for uplink transmission 230 using the second antenna port 250 may be based on an ATPC value that is artificially low. Further, the new pathloss measurement associated with the second antenna port 250 may be lower than the pathloss measurement of the prior antenna. Thus, the new uplink transmit power may be lower than needed to provide for reliable uplink communications, and a BLER for communications with the UE 115-a may increase. Such a situation may result in one or more retransmissions of uplink communications, and subsequent TPC commands that work to increase the uplink transmit power to the suitable level for reliable communications. In extreme cases, such a situation may result in a radio link failure (RLF). Thus, such a situation results in reduced reliability, increased power usage through additional retransmissions or connection reestablishment procedures, and decreased system efficiency.

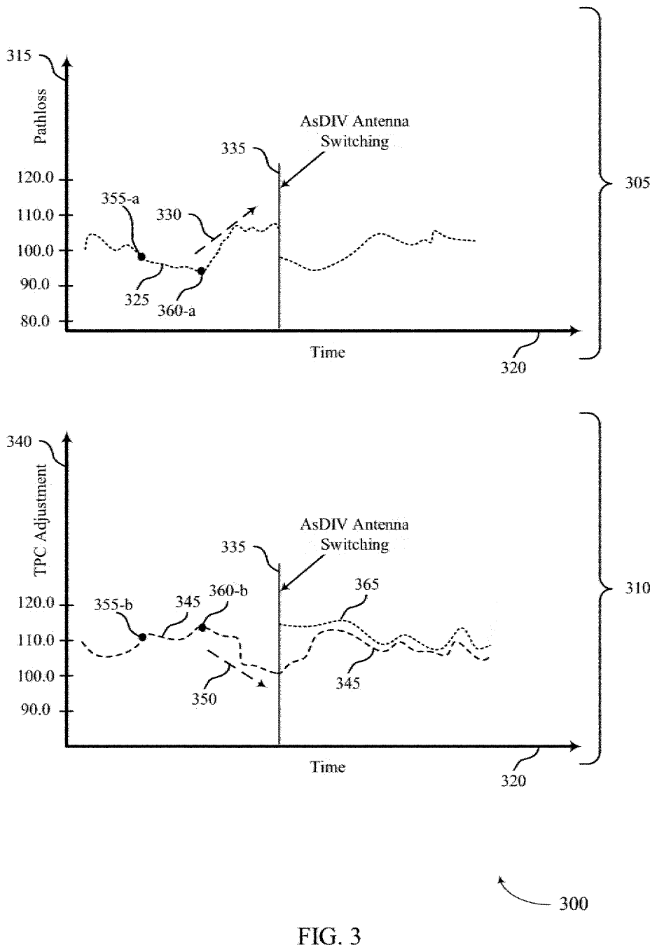

As discussed herein, in some cases UE 115-a may determine an uplink transmit power for an uplink transmission 230 subsequent to an antenna switch to the second antenna port 250 based on an adjustment to the ATPC value associated with the uplink transmission 230, where the adjustment to the ATPC may be made in cases where a pathloss discrepancy exceeds a threshold value. In some cases, the pathloss discrepancy may be calculated by adding negative TPC commands 220 received at the UE 115-a within a time period before an antenna switch. If the pathloss discrepancy exceeds the threshold value, the ATPC may be adjusted to provide a transmit power that is more likely to provide reliable communications subsequent to the antenna switch. In some cases, the adjusted ATPC to be used after the antenna switch may be selected from a set of candidate ATPC values. Additionally, or alternatively, the UE 115-a may record ATPC candidates and associated pathloss values during regular channel measurement occasions when the ATPC value is larger than a threshold. The pathloss discrepancy may be reset when there is a positive TPC from the network, when the ATPC is unchanged for a time interval with multiple uplink transmissions (e.g., indicating that there is no pathloss discrepancy), or a change in a cell ID of a serving cell. FIG. 3 illustrates pathloss measurements and ATPC values, along with candidate values for an ATPC adjustment responsive to an AsDIV antenna switch.

In some cases, the pathloss discrepancy reset when: (1) there are two or more positive TPC commands 220 from the network entity 105-a are received at the UE 115-a within a time interval, (2) the ATPC is unchanged for a time interval with multiple uplink transmissions (e.g., sufficient PUSCH/PUCCH slots to indicate no discrepancy), or (3) there is a change in cell ID of the serving cell of the UE 115-a. In some cases, the adjustment to the ATPC subsequent to the antenna switch is determined based on a product of the difference in measured pathloss of the different antennas, and one or more scaling factors (e.g., an RRC configured first scaling factor, α, and a mobile network operator (MNO) scaling factor), such as according to: new_ATPC=a*PL_drop_delta*Scaling_factor+current ATPC).

FIG. 3 illustrates an example of a pathloss and ATPC versus time 300 that supports techniques for TPC adaptation in antenna switching in accordance with one or more aspects of the present disclosure. Pathloss and ATPC versus time 300 may be implemented by a UE or its components as described herein. For example, operations to identify pathloss and ATPC values may be performed by a UE as described herein, or may be performed by a modem, a chipset, and/or communications manager as discussed herein.

In this example, a first graph 305 illustrates an example of pathloss 315 versus time 320, with pathloss values 325 that show an increase in pathloss values 325 represented by arrow 330, prior to an AsDIV antenna switch 335, at which time the pathloss values drop (e.g., due to the new antenna having more a more favorable channel). A second graph 310 illustrates an example of accumulated TPC adjustments 340 versus time 320, with ATPC values 345 that show a decrease in ATPC values 345 represented by arrow 350, prior to the AsDIV antenna switch 335. As discussed herein, traditional uplink power control techniques would provide ATPC values 345 subsequent to the AsDIV antenna switch 335 that correspond with ATPC values 345 from before the AsDIV antenna switch 335. In some cases, such as in the example of FIG. 3, in which negative TPCs are received when pathloss is increasing, such traditional techniques may cause increased BLER, decreased modulation and coding scheme (MCS) transmissions, and in some more extreme cases may cause RLF. Such situations may result from, for example, UE RSRP results that are unreliable in the condition of low SNR or interference environment, different antenna paths for uplink and downlink that have different channel characteristics, a network entity TPC algorithm that provides negative TPCs, FDD communications in which uplink and downlink channels do not have channel reciprocity, or any combinations thereof.

In cases where the ATPC is adjusted in accordance with techniques as discussed herein, adjusted TPC values 365 may be provided for uplink transmit power determination, which may enhance the reliability and efficiency of communications. In some cases, as part of the AsDIV antenna switch 335 procedure the UE may identify that a pathloss discrepancy is present, which may be used to determine if ATPC adjustment is needed. In some cases, the UE may determine that pathloss has a discrepancy when TPC decreases continuously (e.g., as indicated by arrow 350), and the ATPC accumulates the negative TPCs. In some cases, the pathloss discrepancy reset when there is a positive TPC from the network entity, when the ATPC unchanged for a time interval that has one or more uplink transmissions (e.g., one or more physical uplink shared channel (PUSCH), physical uplink control channel (PUCCH), or sounding reference signal (SRS) slots) scheduled during the time interval; when a cell ID of a serving cell changes, or any combinations thereof. When the UE determines a pathloss discrepancy is present, a recommended ATPC may be used to replace the ATPC after antenna switching.

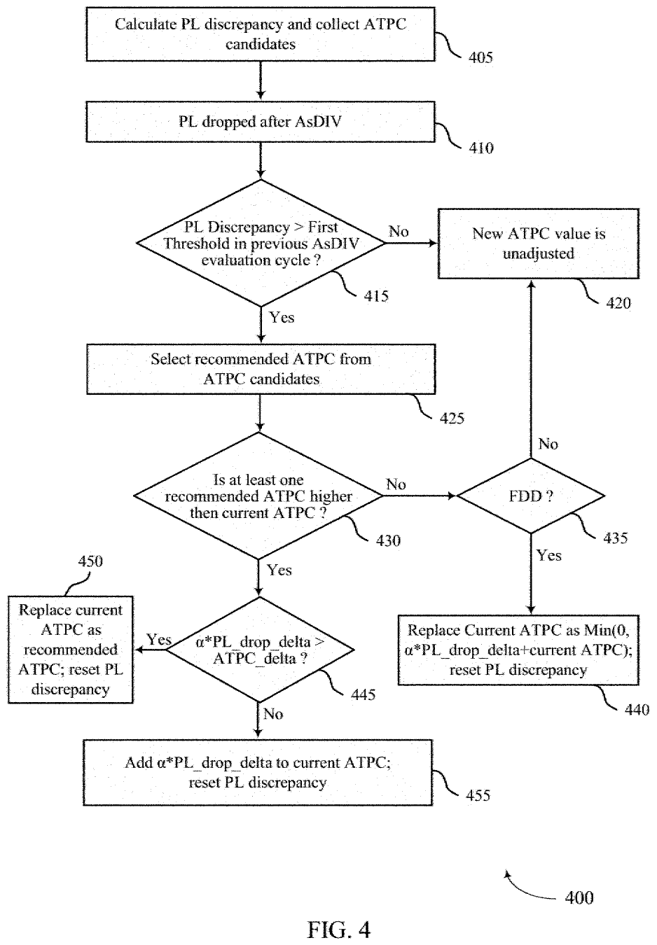

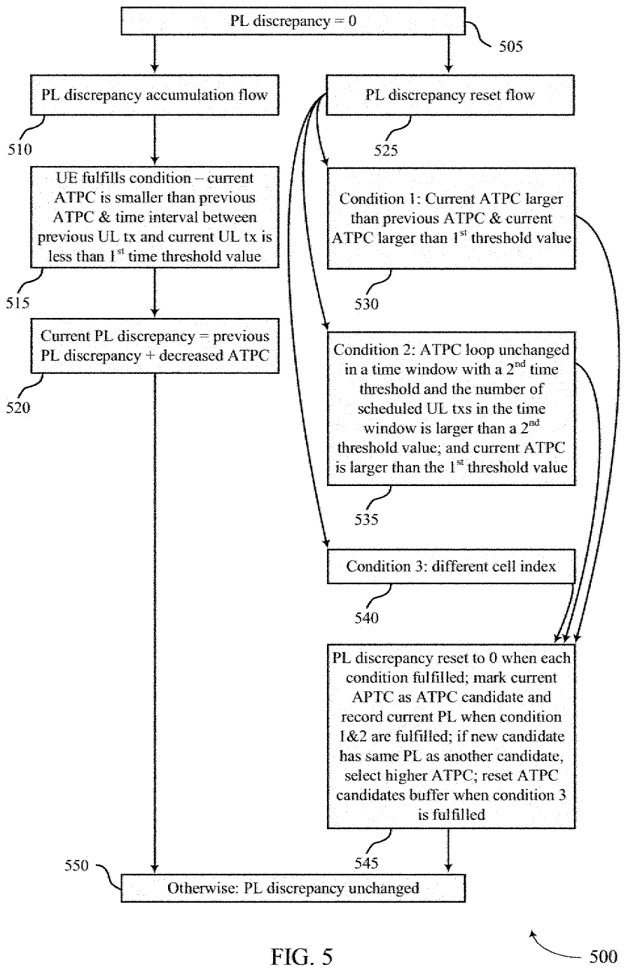

In some cases, the recommended ATPC may be selected from a set of ATPC candidates. In the example of FIG. 3, a first ATPC candidate 355 has a first pathloss 355-a and a corresponding first ATPC value 355-b, and a second ATPC candidate 360 has a second pathloss 360-a and a corresponding second ATPC value 360-b. While two ATPC candidates are illustrated in FIG. 3, additional or fewer ATPC candidates may be present at a UE. In this example, the second pathloss 360-a is a closest pathloss to a pathloss of the new antenna after the antenna switch, and the corresponding second ATPC value 360-b may be selected as the recommended ATPC value after the AsDIV antenna switching 335, and may replace the ATPC value 345 for use in calculating the uplink transmit power using the second antenna subsequent to the AsDIV antenna switching 335. In some cases, ATPC candidate values for pathloss and associated ATPC values may be added to the set of ATPC candidates based on measurements at the UE, as will be described in more detail with reference to FIGS. 4 and 5. In some cases, the pathloss discrepancy and ATPC candidates may be reset when one or more reset conditions are present, examples of which are discussed in more detail with reference to FIGS. 4 and 5.

FIG. 4 illustrates an example of a flowchart 400 that supports techniques for TPC adaptation in antenna switching in accordance with one or more aspects of the present disclosure. The operations of the flowchart 400 may be implemented by a UE or its components as described herein. For example, the operations of the flowchart 400 may be performed by a UE as described with reference to FIGS. 1 through 3, or may be performed by a modem, a chipset, and/or communications manager as discussed herein. In some examples, a UE or associated components may execute a set of instructions to control the functional elements of the UE to perform the described functions.

Additionally, or alternatively, the UE may perform aspects of the described functions using special-purpose hardware. Operations shown and discussed in the example of FIG. 4 may be performed in a different order than the example order shown, or the operations performed may be performed in different orders or at different times. Some operations may be combined or omitted and other operations may be added to the flowchart 400.

In this example, at 405, the UE may calculate a pathloss discrepancy and collects ATPC candidates. As discussed herein, the pathloss discrepancy may be calculated based on a decreasing ATPC, where two or more negative TPCs are received within a time period (e.g., a predetermined time period or a sliding window having a predetermined or configured duration). At 410, the UE may identify that the pathloss has dropped as a result of an antenna switch (e.g., after an AsDIV antenna switch). For example, the reduced pathloss may be identified based on one or more signal strength measurements of one or more reference signals.

At 415, the UE may determine if a pathloss discrepancy exceeds a first threshold value for the previous AsDIV evaluation cycle. For example, the UE may determine that two or more negative TPC commands were received in the sliding window associated with the previous AsDIV evaluation cycle, and that an accumulated value of the negative TPC commands is greater than the first threshold value (e.g., >5 dB). In cases where the pathloss discrepancy does not exceed the first threshold value, the new ATPC value is unadjusted from the prior ATPC value, as indicated at 420.

In cases where the pathloss discrepancy does exceed the first threshold value, the UE may select a recommended ATPC from a set of ATPC candidates, as indicated at 425. In some cases, the set of ATPC candidates may include pairs of values, with one value corresponding to a pathloss and the other value of the pair being the corresponding ATPC value. The UE may identify an ATPC candidate with a closest pathloss to the new antenna pathloss after the antenna switch as the recommended ATPC candidate. In some cases, two or more ATPC candidates may be identified as being the closest to the new antenna pathloss, and the ATPC candidate with the highest ATPC value may be selected at the recommended ATPC candidate.

At 430, the UE may determine if at least one recommended ATPC candidate has a higher ATPC value than a current ATPC value. If none of the recommended ATPC candidates have a higher ATPC value, at 435 the UE may determine if an FDD operation mode is being used. If FDD is being used, as 440 the UE may replace the current ATPC as a min(0, α*PL_drop_delta+current ATPC), and the UE may reset the pathloss discrepancy. In this example, PL_drop_delta is (pathloss before AsDIV)-(pathloss after AsDIV). The value of a may be configured (e.g., by radio resource control (RRC) configuration) as a scaling factor for the difference in pathloss drop. If, at 435, it is determined that FDD is not being used, the new ATPC value may be unadjusted as indicated at 420.

If, at 430, the UE does determine that one or more recommended ATPC candidate has a higher ATPC value than the current ATPC value, at 445 the UE may determine if α*PL_drop_delta exceeds ATPC_delta. In this example, ATPC_delta is computed as (recommended ATPC)-(current ATPC). If yes, at 450 the UE may replace the current ATPC with the recommended ATPC, and reset the pathloss discrepancy. If the determination at 445 is no, at 455 the UE may add α*PL_drop_delta to the current ATPC, and reset the pathloss discrepancy.

FIG. 5 illustrates an example of a flowchart 500 for pathloss discrepancy determination and reset that supports techniques for TPC adaptation in antenna switching in accordance with one or more aspects of the present disclosure. The operations of the flowchart 500 may be implemented by a UE or its components as described herein. For example, the operations of the flowchart 500 may be performed by a UE as described with reference to FIGS. 1 through 4, or may be performed by a modem, a chipset, and/or communications manager as discussed herein. In some examples, a UE or associated components may execute a set of instructions to control the functional elements of the UE to perform the described functions.

Additionally, or alternatively, the UE may perform aspects of the described functions using special-purpose hardware. Operations shown and discussed in the example of FIG. 5 may be performed in a different order than the example order shown, or the operations performed may be performed in different orders or at different times. Some operations may be combined or omitted and other operations may be added to the flowchart 500.

In this example, at 505, the UE may set the pathloss discrepancy to zero. The UE may start a pathloss discrepancy accumulation flow at 510, and may also start a pathloss discrepancy reset flow at 525. In the pathloss discrepancy accumulation flow, at 515, the UE may fulfill the condition that a current ATPC is smaller than a previous ATPC, and a time interval between a previous uplink transmission and a current uplink transmission is less than a first time threshold value (e.g., 100 ms). Based on the condition being fulfilled, at 520 the UE may set a current pathloss discrepancy to be the previous pathloss discrepancy value plus the decreased ATPC (e.g., in dB). If the condition of 515 is not met, at 550 the pathloss discrepancy may be unchanged. Thus, the UE calculated pathloss has discrepancy when TPC decreasing continuously, and this parameter accumulates the negative TPC.

In the pathloss discrepancy reset flow, at 530, the UE may fulfill a first condition that the current ATPC is larger than a previous ATPC and the current ATPC is larger than a first threshold value (e.g., −32 dB). At 535, additionally or alternatively, the UE may fulfill a second condition that the ATPC loop is unchanged in a time window with a second time threshold (e.g., 200 ms) and the number of scheduled uplink transmissions in the time window is larger than a second threshold value (e.g. 8 dB); and the current ATPC is larger than the first threshold value (e.g., −34 dB). At 540, additionally or alternatively, the UE may fulfill a third condition that a different cell index is received (e.g., a different cell ID of a serving cell). At 545, the UE may reset the pathloss discrepancy to zero when each of the first condition, second condition, and third condition is fulfilled; may mark the current APTC as an ATPC candidate and record the current pathloss when the first condition and the second condition are fulfilled; and may reset the reset ATPC candidates buffer when the third condition is fulfilled. In some cases, when recording the current pathloss in the set of candidate ATPCs, is the new candidate has same pathloss as another candidate, the UE may select the higher ATPC value for the set of candidate ATPCs. In cases where the conditions or combinations of conditions are not met, at 550, the pathloss discrepancy may be unchanged.

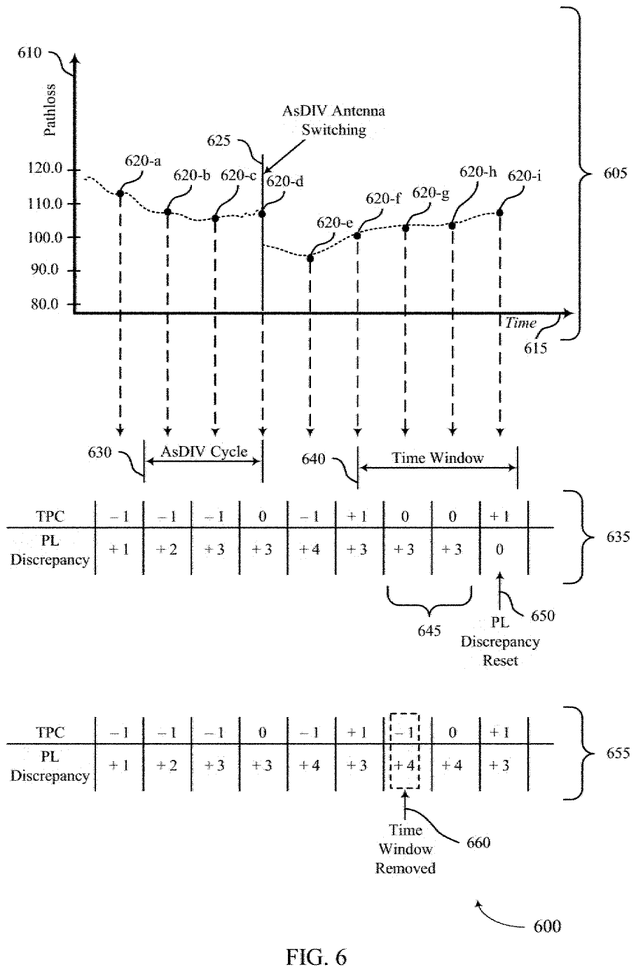

FIG. 6 illustrates an example of a pathloss and ATPC versus time 600 that supports techniques for TPC adaptation in antenna switching in accordance with one or more aspects of the present disclosure. Pathloss and ATPC versus time 600 may be implemented by a UE or its components as described herein. For example, operations to identify pathloss and ATPC values may be performed by a UE as described herein, or may be performed by a modem, a chipset, and/or communications manager as discussed herein.

In this example, a first graph 605 illustrates an example of pathloss 610 versus time 615, with associated TPC indications 620. In this example, pathloss 610 may drop upon an AsDIV antenna switch 625 (e.g., due to the new antenna having more a more favorable channel). In some cases, TPC indications 620 associated with channel measurements at a serving network entity may be provided, as indicated in table 635. In accordance with various aspects, a pathloss discrepancy may be determined based on TPC indications. As illustrated in table 635, negative TPC indications 620-a, 620-b, and 620-c may be received, and such that associated pathloss discrepancy in an AsDIV cycle 630 is positive three (+3). As discussed herein, traditional uplink power control techniques would provide ATPC values subsequent to the AsDIV antenna switch 625 that correspond with ATPC values from before the AsDIV antenna switch 625. In some cases, such as in the example of FIG. 6, such traditional techniques may cause increased BLER, decreased MCS transmissions, and in some more extreme cases may cause RLF. Such situations may result from, for example, UE RSRP results that are unreliable in the condition of low SNR or interference environment, different antenna paths for uplink and downlink that have different channel characteristics, a network entity TPC algorithm that provides negative TPCs, FDD communications in which uplink and downlink channels do not have channel reciprocity, or any combinations thereof.

In cases where the ATPC is adjusted in accordance with techniques as discussed herein, adjusted TPC values may be provided for uplink transmit power determination, which may enhance the reliability and efficiency of communications. In some cases, as part of the AsDIV antenna switch 625 procedure the UE may identify that a pathloss discrepancy is present, which may be used to determine if ATPC adjustment is needed. In some cases, the UE may determine that pathloss has a discrepancy when TPC decreases continuously, and the ATPC accumulates the negative TPCs.

In some cases, the pathloss discrepancy may be reset when there are two or more positive TPCs from the network entity within a time window 640. For example, the time window 640 (e.g., 100 ms) may be initiated upon receipt of positive TPC indication 620-f and, upon receipt of a second positive TPC indication 620-i within time window 640, the pathloss discrepancy may be reset as indicated at 650. The TPC indications 620-g and 620-h that indicate no TPC change in period 645 do not impact the running of the time window 640, in this example. In other cases, such as illustrated at table 655, subsequent to the first positive TPC indication 620-f, a subsequent negative TPC indication 620-g may be received at the UE, and the time window 640 may be removed as indicated at 660. In some cases, the time window 640 also may be reset and suspended upon expiration of the time window 640, in which cases the time window 640 may be re-initiated upon receipt of another positive TPC indication.

Similarly as discussed with reference to FIGS. 3 through 5, in some cases the pathloss discrepancy also may be reset when the ATPC unchanged for a time interval that has one or more uplink transmissions (e.g., one or more PUSCH, PUCCH, or SRS slots) scheduled during a time interval (e.g., that has a same or different time duration as time window 640), and/or when a cell ID of a serving cell changes. When the UE determines a pathloss discrepancy is present, an adjusted ATPC may be used to replace the ATPC after antenna switching. In some cases, the adjusted ATPC may be based on a product of the difference in measured pathloss of the different antennas, and one or more scaling factors, such as an RRC configured first scaling factor (a), and an optional scaling factor (Scaling_factor) that may be associated with a particular operator or type of network hardware. In some cases, the optional scaling factor may be set to one, unless changed. For example, the adjusted ATPC may be determined as:

new ATPC=α*PL_drop_delta*Scaling_factor+current ATPC).

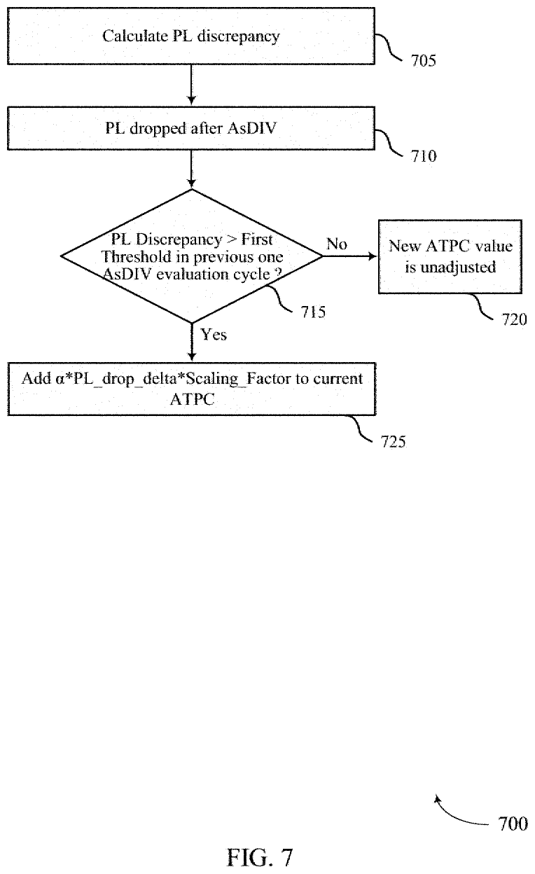

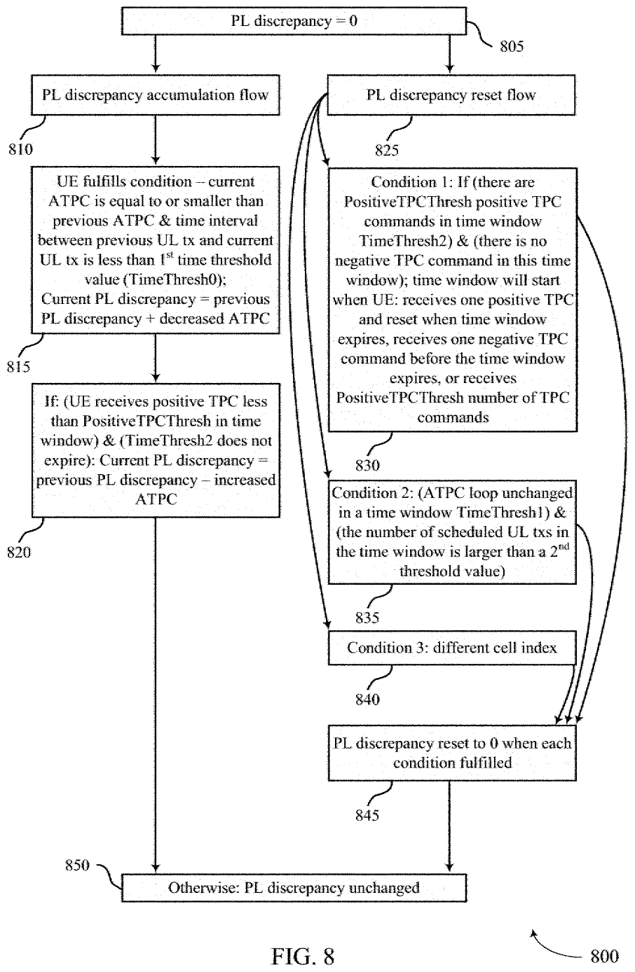

As discussed, the pathloss discrepancy may be reset when one or more reset conditions are present. Examples of pathloss adjustment and pathloss discrepancy reset are discussed in more detail with reference to FIGS. 7 and 8.

FIG. 7 illustrates an example of a flowchart 700 that supports techniques for TPC adaptation in antenna switching in accordance with one or more aspects of the present disclosure. The operations of the flowchart 700 may be implemented by a UE or its components as described herein. For example, the operations of the flowchart 700 may be performed by a UE as described herein, or may be performed by a modem, a chipset, and/or communications manager as discussed herein. In some examples, a UE or associated components may execute a set of instructions to control the functional elements of the UE to perform the described functions.

Additionally, or alternatively, the UE may perform aspects of the described functions using special-purpose hardware. Operations shown and discussed in the example of FIG. 7 may be performed in a different order than the example order shown, or the operations performed may be performed in different orders or at different times. Some operations may be combined or omitted and other operations may be added to the flowchart 700.

In this example, at 705, the UE may calculate a pathloss discrepancy. As discussed herein, the pathloss discrepancy may be calculated based on a decreasing ATPC, where two or more negative TPCs are received within a time period (e.g., a predetermined time period or a sliding window having a predetermined or configured duration). At 710, the UE may identify that the pathloss has dropped as a result of an antenna switch (e.g., after an AsDIV antenna switch). For example, the reduced pathloss may be identified based on one or more signal strength measurements of one or more reference signals.

At 715, the UE may determine if a pathloss discrepancy exceeds a first threshold value for the previous AsDIV evaluation cycle. For example, the UE may determine that a difference in pathloss associated with the different antennas is greater than a configured threshold value (e.g., 1 dB, 2 dB, 5 dB, etc., which may be configured by RRC). In cases where the pathloss discrepancy does not exceed the first threshold value, the new ATPC value is unadjusted from the prior ATPC value, as indicated at 720. At 725, in cases where the pathloss discrepancy does exceed the first threshold value, the UE may compute an adjusted ATPC value (e.g., as new ATPC=α*PL_drop_delta*Scaling_factor+current ATPC). In this example, PL_drop_delta is (pathloss before AsDIV)-(pathloss after AsDIV). In some cases, the value of a may be configured (e.g., by RRC configuration) to provide an adjustment for the difference in pathloss drop. Similarly, in some cases the value of Scaling_factor may be preconfigured at the UE (e.g., based on a network operator associated with the UE), or configured (e.g., by RRC configuration, or other configuration) based on a particular operator or type of network hardware. In some cases, such a scaling factor may be optional, or may be set to one unless changed.

FIG. 8 illustrates an example of a flowchart 800 for pathloss discrepancy determination and reset that supports techniques for TPC adaptation in antenna switching in accordance with one or more aspects of the present disclosure. The operations of the flowchart 800 may be implemented by a UE or its components as described herein. For example, the operations of the flowchart 800 may be performed by a UE as described with reference to FIGS. 1 and 2, or may be performed by a modem, a chipset, and/or communications manager as discussed herein. In some examples, a UE or associated components may execute a set of instructions to control the functional elements of the UE to perform the described functions.

Additionally, or alternatively, the UE may perform aspects of the described functions using special-purpose hardware. Operations shown and discussed in the example of FIG. 8 may be performed in a different order than the example order shown, or the operations performed may be performed in different orders or at different times. Some operations may be combined or omitted and other operations may be added to the flowchart 800.

In this example, at 805, the UE may set the pathloss discrepancy to zero. The UE may start a pathloss discrepancy accumulation flow at 810, and may also start a pathloss discrepancy reset flow at 825. In the pathloss discrepancy accumulation flow, at 815, the UE may fulfill the condition that a current ATPC is equal to or smaller than a previous ATPC, and a time interval between a previous uplink transmission and a current uplink transmission is less than a first time threshold value (e.g., TimeThresh0 which may be 100 ms in some examples). Based on the condition being fulfilled, at 820 if (1) the UE receives a positive TPC less than a positive TPC threshold (PositiveTPCThresh) in a time window, and (2) a third time threshold value (e.g. TimeThresh2, which may be 100 ms in some examples), the UE may set the current pathloss discrepancy to be equal to the previous pathloss discrepancy minus the increased ATPC. If the condition of 815 is not met, at 850 the pathloss discrepancy may be unchanged.

In the pathloss discrepancy reset flow, at 830, the UE may fulfill a first condition that If (1) there are PositiveTPCThresh positive TPC commands within a time window corresponding to the third time threshold value (TimeThresh2), and (2) there is no negative TPC command in this time window; the time window will start when the UE receives one positive TPC, and the time window will reset when time window expires, when the UE receives a negative TPC command before the time window expires, or the UE receives a PositiveTPCThresh number of positive TPC commands (e.g., two positive TPC commands).

At 835, additionally or alternatively, the UE may fulfill a second condition that (1) the ATPC loop is unchanged in a time window corresponding to a second time threshold value (e.g., TimeThresh1, which may be 200 ms in some examples), and (2) the number of scheduled uplink transmissions in the time window is larger than a threshold value (e.g., Thresh1, which may be 8 in some examples). At 840, additionally or alternatively, the UE may fulfill a third condition that a different cell index is received (e.g., a different cell ID of a serving cell). At 845, the UE may reset the pathloss discrepancy to zero when one or more of the first condition, second condition, and third condition is fulfilled. In cases where the conditions or combinations of conditions are not met, at 850, the pathloss discrepancy may be unchanged. In some cases, determination of pathloss discrepancy may be determined at a UE through execution of execute a set of instructions to control the functional elements of the UE to make such a determination. One example of such a set of instructions may include:

```
if current APTC< pervious ATPC
  pl_discrepancy = pl_discrepancy + pervious ATPC− current APTC;
  continue_positive_TPC = 0;
  timer2 = 0;
elseif current APTC >pervious ATPC
  continue_positive_TPC = continue_positive_TPC + 1;
  pl_discrepancy = pl_discrepancy + pervious ATPC− current APTC;
  if (continue_positive_TPC == PositiveTPCThresh)
    continue_positive_TPC = 0;
    pl_discrepancy = 0;
  end
  if continue_positive_TPC > 1
    timer2 = timer2 + the time for current APTC− the time for pervious
APTC
    if (timer2 > TimeThresh2)
      timer2 = 0;
      continue_positive_TPC = 0;
    end
  end
elseif current APTC = pervious ATPC
  current pl_discrepancy = pervious pl_discrepancy;
  if continue_positive_TPC > 0
    timer2 = timer2 + the time for current APTC− the time for pervious
APTC
    if (timer2 > TimeThresh2)
      timer2 = 0;
      continue_positive_TPC = 0;
    end
  end
end
if current APTC = pervious ATPC % Acc TPC keep unchange
  timer1 = timer1 + the time for current APTC− the time for pervious APTC
% record the time length for TPC unchange
  tpc_num = tpc_num + 1; % record how many PUSCH scheduled
  if (timer1 > TimeThresh1)&&(tpc_num>Thresh1) % reset pl_discrepancy
when 200ms no TPC update and there are more than 8 PUSCH slots
pl_discrepancy= 0;
timer1 = 0;
tpc_num = 0;
  end
else
  timer1 = 0;
end.
```

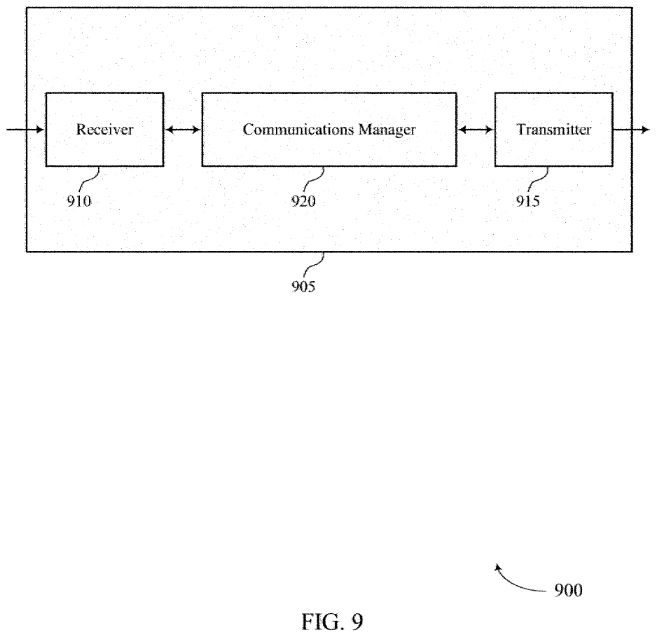

FIG. 9 illustrates a block diagram 900 of a device 905 that supports techniques for TPC adaptation in antenna switching in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for TPC adaptation in antenna switching). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for TPC adaptation in antenna switching). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of techniques for TPC adaptation in antenna switching as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. For example, the communications manager 920 may be configured as or otherwise support a means for receiving one or more TPC commands for an uplink transmit power for an uplink transmission via at least a first antenna, the one or more TPC commands indicating a decrease in an uplink transmit power, where the uplink transmit power for the uplink transmission is based on an accumulation of a set of multiple TPC commands. The communications manager 920 may be configured as or otherwise support a means for determining, subsequent to the receiving the one or more TPC commands, to switch from the first antenna to a second antenna for one or more communications. The communications manager 920 may be configured as or otherwise support a means for determining a pathloss discrepancy based on one or more pathloss measurements and the one or more TPC commands associated with the first antenna. The communications manager 920 may be configured as or otherwise support a means for adjusting, basing at least in part on the pathloss discrepancy, an ATPC value associated with a TPC procedure for communications via the second antenna.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for transmit power adjustments associated with AsDIV based on pathloss discrepancy associated with an antenna switch, which may provide enhanced likelihood that uplink communications will have a robust SNR value, may help to maintain uplink throughput and reduce uplink BLER spikes, reduce workload, and provide reduced power consumption and reduced latency.

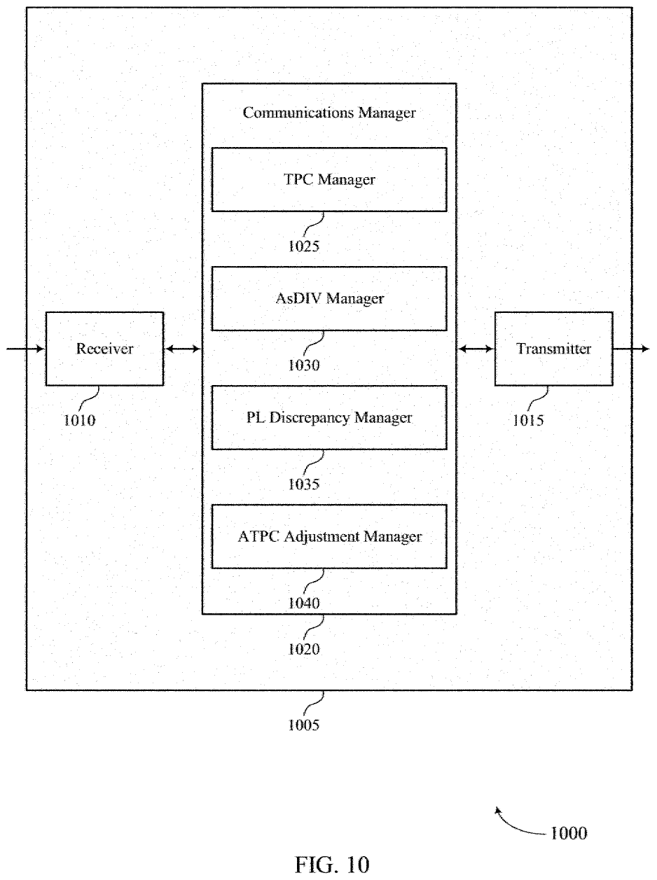

FIG. 10 illustrates a block diagram 1000 of a device 1005 that supports techniques for TPC adaptation in antenna switching in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for TPC adaptation in antenna switching). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for TPC adaptation in antenna switching). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for TPC adaptation in antenna switching as described herein. For example, the communications manager 1020 may include a TPC manager 1025, an AsDIV manager 1030, a PL discrepancy manager 1035, an ATPC adjustment manager 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a UE in accordance with examples as disclosed herein. The TPC manager 1025 may be configured as or otherwise support a means for receiving one or more TPC commands for an uplink transmit power for an uplink transmission via at least a first antenna, the one or more TPC commands indicating a decrease in an uplink transmit power, where the uplink transmit power for the uplink transmission is based on an accumulation of a set of multiple TPC commands. The AsDIV manager 1030 may be configured as or otherwise support a means for determining, subsequent to the receiving the one or more TPC commands, to switch from the first antenna to a second antenna for one or more communications. The PL discrepancy manager 1035 may be configured as or otherwise support a means for determining a pathloss discrepancy based on one or more pathloss measurements and the one or more TPC commands associated with the first antenna. The ATPC adjustment manager 1040 may be configured as or otherwise support a means for adjusting, based on the pathloss discrepancy, an ATPC value associated with a TPC procedure for communications via the second antenna.

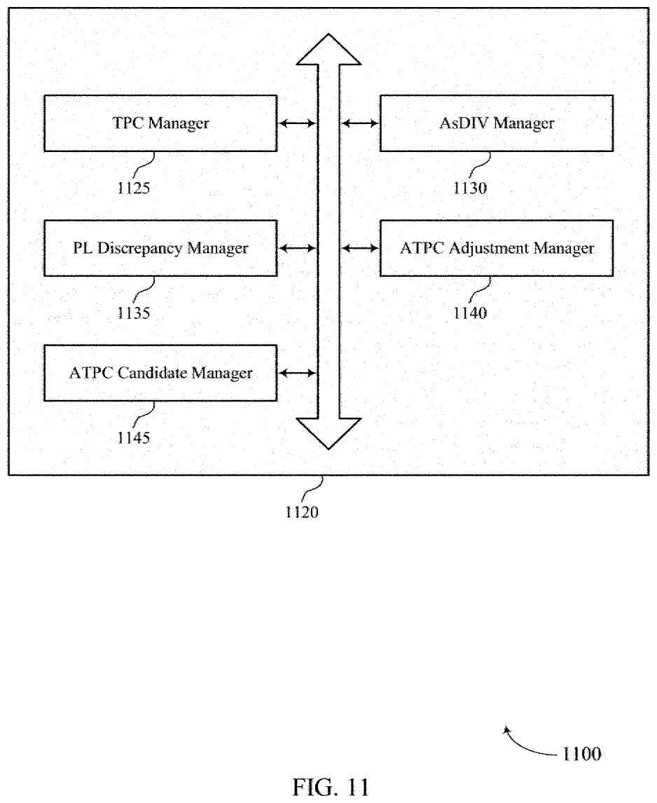

FIG. 11 illustrates a block diagram 1100 of a communications manager 1120 that supports techniques for TPC adaptation in antenna switching in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for TPC adaptation in antenna switching as described herein. For example, the communications manager 1120 may include a TPC manager 1125, an AsDIV manager 1130, a PL discrepancy manager 1135, an ATPC adjustment manager 1140, an ATPC candidate manager 1145, or any combination thereof. Each of these components may communicate, directly or indirectly, with one another (e.g., via one or more buses).

The communications manager 1120 may support wireless communications at a UE in accordance with examples as disclosed herein. The TPC manager 1125 may be configured as or otherwise support a means for receiving one or more TPC commands for an uplink transmit power for an uplink transmission via at least a first antenna, the one or more TPC commands indicating a decrease in an uplink transmit power, where the uplink transmit power for the uplink transmission is based on an accumulation of a set of multiple TPC commands. The AsDIV manager 1130 may be configured as or otherwise support a means for determining, subsequent to the receiving the one or more TPC commands, to switch from the first antenna to a second antenna for one or more communications. The PL discrepancy manager 1135 may be configured as or otherwise support a means for determining a pathloss discrepancy based on one or more pathloss measurements and the one or more TPC commands associated with the first antenna. The ATPC adjustment manager 1140 may be configured as or otherwise support a means for adjusting, based on the pathloss discrepancy, an ATPC value associated with a TPC procedure for communications via the second antenna.

In some examples, to support determining the pathloss discrepancy, the TPC manager 1125 may be configured as or otherwise support a means for determining that two or more TPC commands that indicate a decrease in the uplink transmit power are received within a predetermined time interval.

In some examples, to support adjusting the ATPC value, the ATPC adjustment manager 1140 may be configured as or otherwise support a means for selecting a first ATPC value from a set of candidate ATPC values based on a pathloss associated with each of the candidate ATPC values and a pathloss associated with the second antenna. In some examples, to support adjusting the ATPC value, the ATPC adjustment manager 1140 may be configured as or otherwise support a means for adjusting the ATPC value based on the first ATPC value.

In some examples, to support adjusting the ATPC value, the ATPC adjustment manager 1140 may be configured as or otherwise support a means for determining a first value that corresponds to difference between a first pathloss measurement associated with the first antenna and a second pathloss measurement associated with the second antenna. In some examples, to support adjusting the ATPC value, the ATPC adjustment manager 1140 may be configured as or otherwise support a means for computing a second value as a product of the first value and at least one scaling factor. In some examples, to support adjusting the ATPC value, the ATPC adjustment manager 1140 may be configured as or otherwise support a means for adding the second value to the accumulated transmit power control value.

In some examples, the PL discrepancy manager 1135 may be configured as or otherwise support a means for resetting the pathloss discrepancy based at least in part on one or more of a receipt of two or more transmit power control commands that indicate an increase in the uplink transmit power within a time window, the accumulated transmit power control value being unchanged for a predetermined time interval in which one or more uplink communications are transmitted, or a change in a cell identification of a serving cell. In some examples, the time window starts upon receipt of a first transmit power control command that indicates an increase in the uplink transmit power, and the time window is reset and suspended upon expiration of the time window or receipt of a second transmit power control command that indicates a decrease in the uplink transmit power.

In some examples, the ATPC candidate manager 1145 may be configured as or otherwise support a means for identifying, for at least one measurement instance prior to the switch from the first antenna to a second antenna, a pathloss associated with the first antenna. In some examples, the ATPC candidate manager 1145 may be configured as or otherwise support a means for storing an ATPC value and the identified pathloss as a candidate ATPC value of the set of candidate ATPC values.

In some examples, the ATPC candidate manager 1145 may be configured as or otherwise support a means for determining, subsequent to the identifying, to store the ATPC value and the identified pathloss based on. In some examples, the ATPC candidate manager 1145 may be configured as or otherwise support a means for the associated ATPC value being larger than a prior ATPC value and a threshold value. In some examples, the ATPC candidate manager 1145 may be configured as or otherwise support a means for the associated ATPC value exceeding the threshold value and being unchanged for at least a predetermined time interval in which one or more uplink communications are transmitted.

In some examples, the ATPC candidate manager 1145 may be configured as or otherwise support a means for resetting the set of candidate ATPC values responsive to a cell identification change of a serving cell for uplink transmissions via the first antenna or the second antenna. In some examples, the pathloss discrepancy is based on an accumulated quantity of TPC commands that indicate a decrease in the uplink transmit power.

In some examples, the PL discrepancy manager 1135 may be configured as or otherwise support a means for resetting the pathloss discrepancy based at least in part on one or more of a receipt of two or more TPC commands that indicate an increase in the uplink transmit power within a time window, the ATPC value being unchanged for a predetermined time interval in which one or more uplink communications are transmitted, or a change in a cell identification of a serving cell. In some cases, the time window starts upon receipt of a first TPC command that indicates an increase in the uplink transmit power, and the time window is reset and suspended upon expiration of the time window or receipt of a second TPC command that indicates the decrease in the uplink transmit power.

In some examples, the PL discrepancy manager 1135 may be configured as or otherwise support a means for resetting the pathloss discrepancy based on one or more of a receipt of a TPC command that indicates an increase in the uplink transmit power, the ATPC value being unchanged for a predetermined time interval in which one or more uplink communications are transmitted, or a change in a cell identification of a serving cell. In some examples, the adjusting the ATPC value is performed responsive to the pathloss discrepancy exceeding a threshold value. In some examples, the adjusting the ATPC value is based on a first candidate ATPC value from a set of candidate ATPC values that has a closest associated pathloss to an identified pathloss for the second antenna.

In some examples, the set of candidate ATPC values include at least the first candidate ATPC value associated with a first pathloss and a second candidate ATPC value associated with a second pathloss, and the ATPC adjustment manager 1140 may be configured as or otherwise support a means for determining that a difference between the identified pathloss for the second antenna and the first pathloss has a same value as a difference between the identified pathloss for the second antenna and the second pathloss. In some examples, the set of candidate ATPC values include at least the first candidate ATPC value associated with a first pathloss and a second candidate ATPC value associated with a second pathloss, and the ATPC adjustment manager 1140 may be configured as or otherwise support a means for selecting the first candidate ATPC value responsive to the first candidate ATPC value having a higher value than the second candidate ATPC value.

In some examples, the adjusting the ATPC value is performed responsive to the first candidate ATPC value having a higher value than a current ATPC value subsequent to the switch from the first antenna to the second antenna. In some examples, the determining the pathloss discrepancy is responsive to a change in an estimated pathloss subsequent to the switch to the second antenna exceeding an amount of the adjustment in the ATPC value.

In some examples, to support determining the pathloss discrepancy, the PL discrepancy manager 1135 may be configured as or otherwise support a means for scaling the change in the estimated pathloss subsequent to the switch to the second antenna according to a scaling factor to determine a scaled estimated pathloss difference. In some examples, to support determining the pathloss discrepancy, the PL discrepancy manager 1135 may be configured as or otherwise support a means for comparing the scaled estimated pathloss difference to the amount of the adjustment in the ATPC value, and where the adjusting is performed responsive to the scaled estimated pathloss difference exceeding the amount of the adjustment in the ATPC value. In some examples, the PL discrepancy manager 1135 may be configured as or otherwise support a means for resetting a value associated with the pathloss discrepancy responsive to the adjusting the ATPC value.

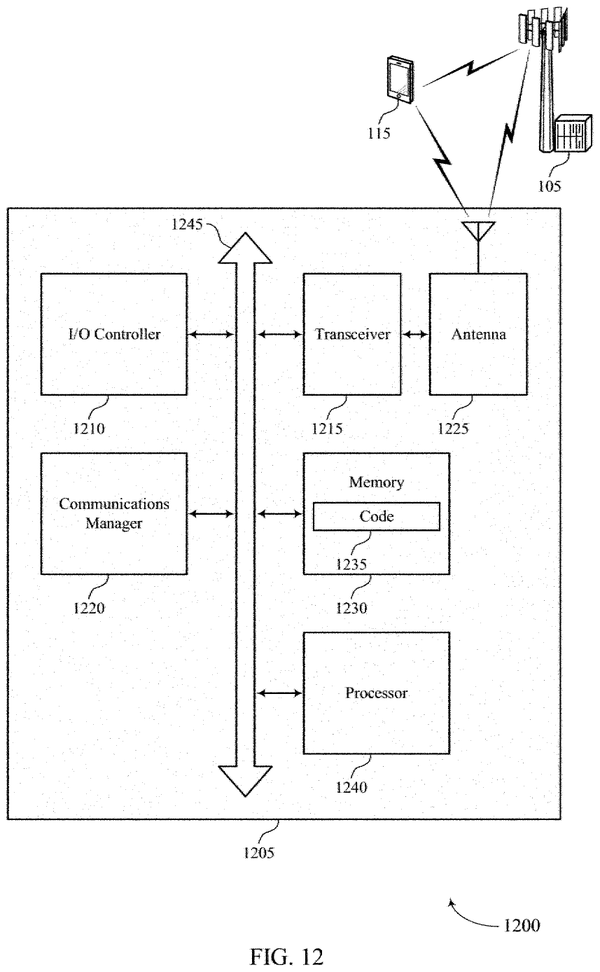

FIG. 12 illustrates a diagram of a system 1200 including a device 1205 that supports techniques for TPC adaptation in antenna switching in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for TPC adaptation in antenna switching). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a UE in accordance with examples as disclosed herein. For example, the communications manager 1220 may be configured as or otherwise support a means for receiving one or more TPC commands for an uplink transmit power for an uplink transmission via at least a first antenna, the one or more TPC commands indicating a decrease in an uplink transmit power, where the uplink transmit power for the uplink transmission is based on an accumulation of a set of multiple TPC commands. The communications manager 1220 may be configured as or otherwise support a means for determining, subsequent to the receiving the one or more TPC commands, to switch from the first antenna to a second antenna for one or more communications. The communications manager 1220 may be configured as or otherwise support a means for determining a pathloss discrepancy based on one or more pathloss measurements and the one or more TPC commands associated with the first antenna. The communications manager 1220 may be configured as or otherwise support a means for adjusting, basing at least in part on the pathloss discrepancy, an ATPC value associated with a TPC procedure for communications via the second antenna.

By including or configuring the communications manager 1220 in accordance with examples as described herein, the device 1205 may support techniques for transmit power adjustments associated with AsDIV based on pathloss discrepancy associated with an antenna switch, which may provide enhanced likelihood that uplink communications will have a robust SNR value, may help to maintain uplink throughput and reduce uplink BLER spikes, reduce workload, and provide reduced power consumption and reduced latency.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for TPC adaptation in antenna switching as described herein, or the processor 1240 and the memory 1230 may be otherwise configured to perform or support such operations.

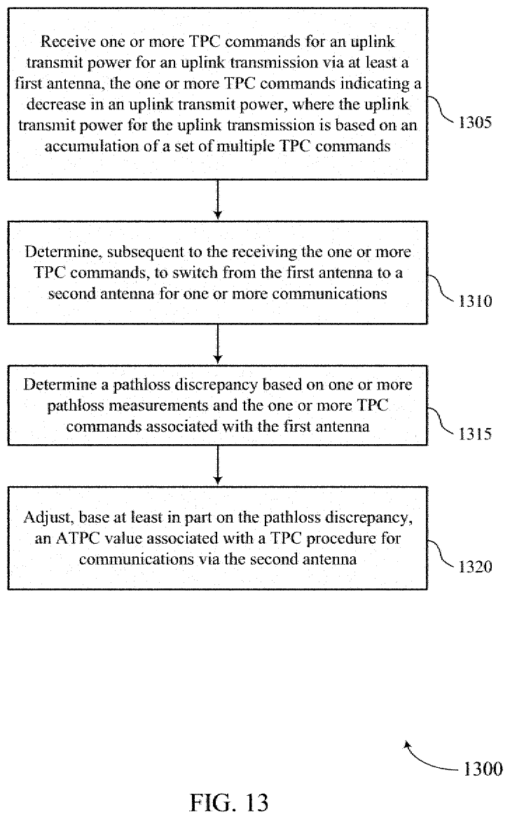

FIG. 13 illustrates a flowchart showing a method 1300 that supports techniques for TPC adaptation in antenna switching in accordance with one or more aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include receiving one or more TPC commands for an uplink transmit power for an uplink transmission via at least a first antenna, the one or more TPC commands indicating a decrease in an uplink transmit power, where the uplink transmit power for the uplink transmission is based on an accumulation of a set of multiple TPC commands. The operations of 1305 may be performed in accordance with examples as disclosed herein. In some examples, aspects of the operations of 1305 may be performed by a TPC manager 1125 as described with reference to FIG. 11.

At 1310, the method may include determining, subsequent to the receiving the one or more TPC commands, to switch from the first antenna to a second antenna for one or more communications. The operations of 1310 may be performed in accordance with examples as disclosed herein. In some examples, aspects of the operations of 1310 may be performed by an AsDIV manager 1130 as described with reference to FIG. 11.

At 1315, the method may include determining a pathloss discrepancy based on one or more pathloss measurements and the one or more TPC commands associated with the first antenna. The operations of 1315 may be performed in accordance with examples as disclosed herein. In some examples, aspects of the operations of 1315 may be performed by a PL discrepancy manager 1135 as described with reference to FIG. 11.

At 1320, the method may include adjusting, based on the pathloss discrepancy, an ATPC value associated with a TPC procedure for communications via the second antenna. The operations of 1320 may be performed in accordance with examples as disclosed herein. In some examples, aspects of the operations of 1320 may be performed by an ATPC adjustment manager 1140 as described with reference to FIG. 11.

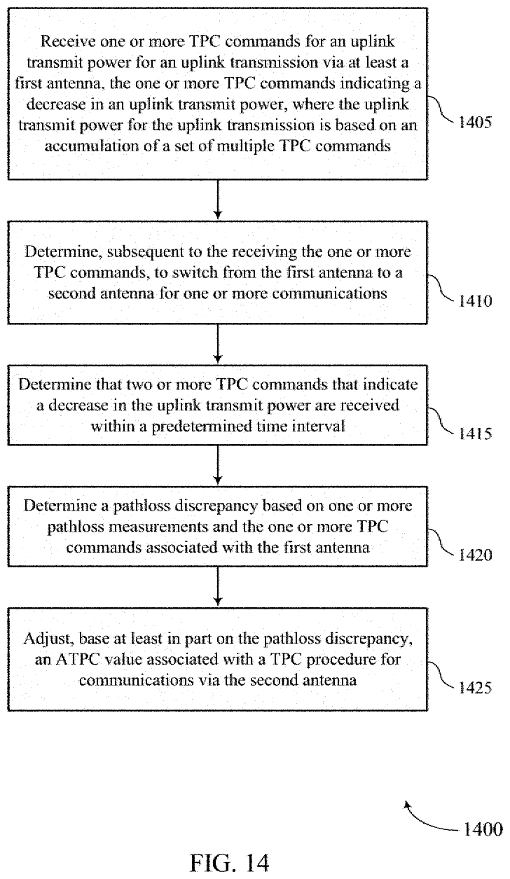

FIG. 14 illustrates a flowchart showing a method 1400 that supports techniques for TPC adaptation in antenna switching in accordance with one or more aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1405, the method may include receiving one or more TPC commands for an uplink transmit power for an uplink transmission via at least a first antenna, the one or more TPC commands indicating a decrease in an uplink transmit power, where the uplink transmit power for the uplink transmission is based on an accumulation of a set of multiple TPC commands. The operations of 1405 may be performed in accordance with examples as disclosed herein. In some examples, aspects of the operations of 1405 may be performed by a TPC manager 1125 as described with reference to FIG. 11.

At 1410, the method may include determining, subsequent to the receiving the one or more TPC commands, to switch from the first antenna to a second antenna for one or more communications. The operations of 1410 may be performed in accordance with examples as disclosed herein. In some examples, aspects of the operations of 1410 may be performed by an AsDIV manager 1130 as described with reference to FIG. 11.

At 1415, the method may include determining that two or more TPC commands that indicate a decrease in the uplink transmit power are received within a predetermined time interval. The operations of 1415 may be performed in accordance with examples as disclosed herein. In some examples, aspects of the operations of 1415 may be performed by a TPC manager 1125 as described with reference to FIG. 11.

At 1420, the method may include determining a pathloss discrepancy based on one or more pathloss measurements and the one or more TPC commands associated with the first antenna. The operations of 1420 may be performed in accordance with examples as disclosed herein. In some examples, aspects of the operations of 1420 may be performed by a PL discrepancy manager 1135 as described with reference to FIG. 11.

At 1425, the method may include adjusting, based on the pathloss discrepancy, an ATPC value associated with a TPC procedure for communications via the second antenna. The operations of 1425 may be performed in accordance with examples as disclosed herein. In some examples, aspects of the operations of 1425 may be performed by an ATPC adjustment manager 1140 as described with reference to FIG. 11.

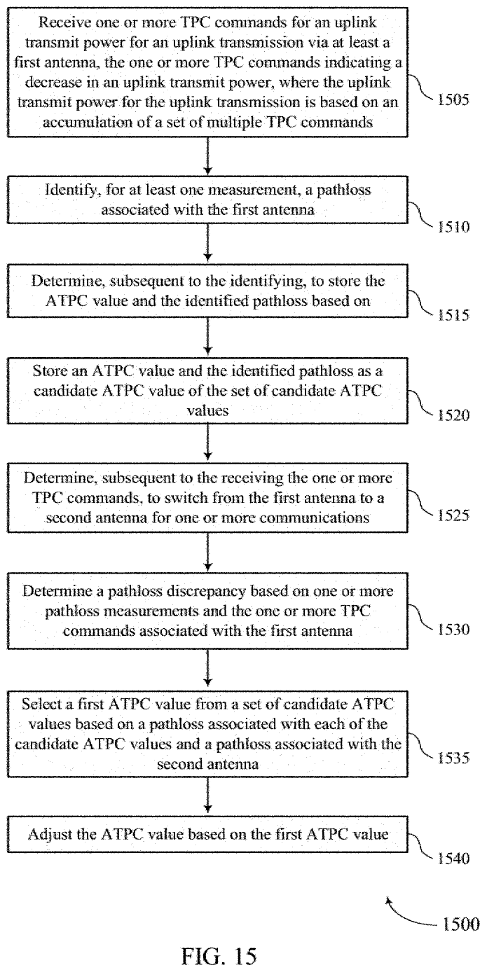

FIG. 15 illustrates a flowchart showing a method 1500 that supports techniques for TPC adaptation in antenna switching in accordance with one or more aspects of the present disclosure. The operations of the method 1500 may be implemented by a UE or its components as described herein. For example, the operations of the method 1500 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1505, the method may include receiving one or more TPC commands for an uplink transmit power for an uplink transmission via at least a first antenna, the one or more TPC commands indicating a decrease in an uplink transmit power, where the uplink transmit power for the uplink transmission is based on an accumulation of a set of multiple TPC commands. The operations of 1505 may be performed in accordance with examples as disclosed herein. In some examples, aspects of the operations of 1505 may be performed by a TPC manager 1125 as described with reference to FIG. 11.

At 1510, the method may include identifying, for at least one measurement instance prior to the switch from the first antenna to a second antenna, a pathloss associated with the first antenna. The operations of 1510 may be performed in accordance with examples as disclosed herein. In some examples, aspects of the operations of 1510 may be performed by an ATPC candidate manager 1145 as described with reference to FIG. 11.

At 1515, the method may include determining, subsequent to the identifying, to store the ATPC value and the identified pathloss. The operations of 1515 may be performed in accordance with examples as disclosed herein. In some examples, aspects of the operations of 1515 may be performed by an ATPC candidate manager 1145 as described with reference to FIG. 11. In some cases, the determination to store the ATPC may be based at least in part on the associated ATPC value exceeding the threshold value and being unchanged for at least a predetermined time interval in which one or more uplink communications are transmitted.

At 1520, the method may include storing an ATPC value and the identified pathloss as a candidate ATPC value of the set of candidate ATPC values. The operations of 1520 may be performed in accordance with examples as disclosed herein. In some examples, aspects of the operations of 1520 may be performed by an ATPC candidate manager 1145 as described with reference to FIG. 11.

At 1525, the method may include determining, subsequent to the receiving the one or more TPC commands, to switch from the first antenna to a second antenna for one or more communications. The operations of 1525 may be performed in accordance with examples as disclosed herein. In some examples, aspects of the operations of 1525 may be performed by an AsDIV manager 1130 as described with reference to FIG. 11.

At 1530, the method may include determining a pathloss discrepancy based on one or more pathloss measurements and the one or more TPC commands associated with the first antenna. The operations of 1530 may be performed in accordance with examples as disclosed herein. In some examples, aspects of the operations of 1530 may be performed by a PL discrepancy manager 1135 as described with reference to FIG. 11.

At 1535, the method may include selecting a first ATPC value from a set of candidate ATPC values based on a pathloss associated with each of the candidate ATPC values and a pathloss associated with the second antenna. The operations of 1535 may be performed in accordance with examples as disclosed herein. In some examples, aspects of the operations of 1535 may be performed by an ATPC adjustment manager 1140 as described with reference to FIG. 11.

At 1540, the method may include adjusting the ATPC value based on the first ATPC value. The operations of 1540 may be performed in accordance with examples as disclosed herein. In some examples, aspects of the operations of 1540 may be performed by an ATPC adjustment manager 1140 as described with reference to FIG. 11.

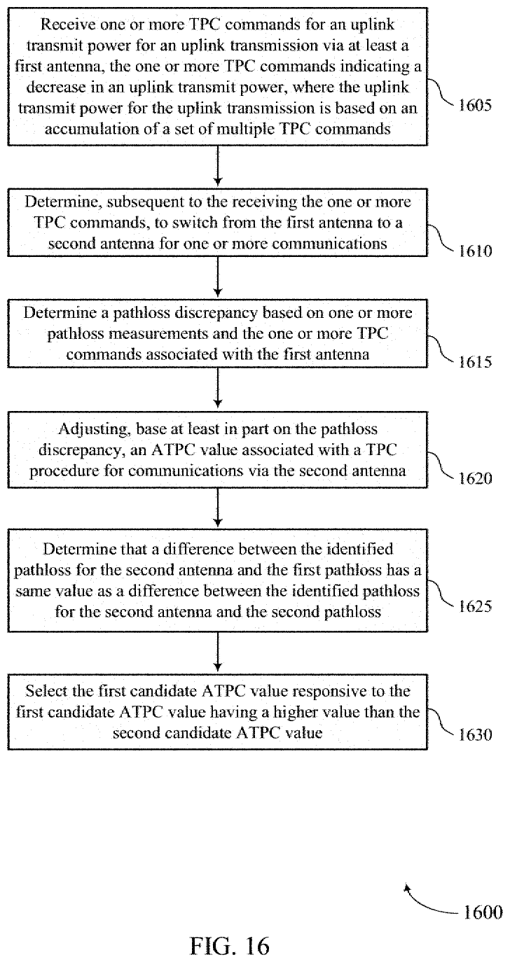

FIG. 16 illustrates a flowchart showing a method 1600 that supports techniques for TPC adaptation in antenna switching in accordance with one or more aspects of the present disclosure. The operations of the method 1600 may be implemented by a UE or its components as described herein. For example, the operations of the method 1600 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1605, the method may include receiving one or more TPC commands for an uplink transmit power for an uplink transmission via at least a first antenna, the one or more TPC commands indicating a decrease in an uplink transmit power, where the uplink transmit power for the uplink transmission is based on an accumulation of a set of multiple TPC commands. The operations of 1605 may be performed in accordance with examples as disclosed herein. In some examples, aspects of the operations of 1605 may be performed by a TPC manager 1125 as described with reference to FIG. 11.

At 1610, the method may include determining, subsequent to the receiving the one or more TPC commands, to switch from the first antenna to a second antenna for one or more communications. The operations of 1610 may be performed in accordance with examples as disclosed herein. In some examples, aspects of the operations of 1610 may be performed by an AsDIV manager 1130 as described with reference to FIG. 11.

At 1615, the method may include determining a pathloss discrepancy based on one or more pathloss measurements and the one or more TPC commands associated with the first antenna. The operations of 1615 may be performed in accordance with examples as disclosed herein. In some examples, aspects of the operations of 1615 may be performed by a PL discrepancy manager 1135 as described with reference to FIG. 11.

At 1620, the method may include adjusting, based on the pathloss discrepancy, an ATPC value associated with a TPC procedure for communications via the second antenna. The operations of 1620 may be performed in accordance with examples as disclosed herein. In some examples, aspects of the operations of 1620 may be performed by an ATPC adjustment manager 1140 as described with reference to FIG. 11. In some cases, the adjusting the ATPC value is based on a first candidate ATPC value from a set of candidate ATPC values that has a closest associated pathloss to an identified pathloss for the second antenna. In some cases, the set of candidate ATPC values include at least the first candidate ATPC value associated with a first pathloss and a second candidate ATPC value associated with a second pathloss.

At 1625, the method may include determining that a difference between the identified pathloss for the second antenna and the first pathloss has a same value as a difference between the identified pathloss for the second antenna and the second pathloss. The operations of 1625 may be performed in accordance with examples as disclosed herein. In some examples, aspects of the operations of 1625 may be performed by an ATPC adjustment manager 1140 as described with reference to FIG. 11.

At 1630, the method may include selecting the first candidate ATPC value responsive to the first candidate ATPC value having a higher value than the second candidate ATPC value. The operations of 1630 may be performed in accordance with examples as disclosed herein. In some examples, aspects of the operations of 1630 may be performed by an ATPC adjustment manager 1140 as described with reference to FIG. 11.

The following provides an overview of aspects of the present disclosure:

Aspect 1: A method for wireless communications at a UE, comprising: receiving one or more transmit power control commands for an uplink transmit power for an uplink transmission via at least a first antenna, the one or more transmit power control commands indicating a decrease in an uplink transmit power, wherein the uplink transmit power for the uplink transmission is based on an accumulation of a plurality of transmit power control commands; determining, subsequent to the receiving the one or more transmit power control commands, to switch from the first antenna to a second antenna for one or more communications; determining a pathloss discrepancy based at least in part on one or more pathloss measurements and the one or more transmit power control commands associated with the first antenna; and adjusting, based at least in part on the pathloss discrepancy, an accumulated transmit power control value associated with a transmit power control procedure for communications via the second antenna.

Aspect 2: The method of aspect 1, wherein the determining the pathloss discrepancy comprises: determining that two or more transmit power control commands that indicate a decrease in the uplink transmit power are received within a predetermined time interval.

Aspect 3: The method of any of aspects 1 through 2, wherein the adjusting the accumulated transmit power control value comprises: selecting a first accumulated transmit power control value from a set of candidate accumulated transmit power control values based at least in part on a pathloss associated with each of the candidate accumulated transmit power control values and a pathloss associated with the second antenna; and adjusting the accumulated transmit power control value based at least in part on the first accumulated transmit power control value.

Aspect 4: The method of aspect 3, further comprising: identifying, for at least one measurement instance prior to the switch from the first antenna to a second antenna, a pathloss associated with the first antenna; and storing an accumulated transmit power control value and the identified pathloss as a candidate accumulated transmit power control value of the set of candidate accumulated transmit power control values.

Aspect 5: The method of aspect 4, further comprising: determining, subsequent to the identifying, to store the accumulated transmit power control value and the identified pathloss based at least in part on: the associated accumulated transmit power control value being larger than a prior accumulated transmit power control value and a threshold value, or the associated accumulated transmit power control value exceeding the threshold value and being unchanged for at least a predetermined time interval in which one or more uplink communications are transmitted.

Aspect 6: The method of any of aspects 4 through 5, further comprising: resetting the set of candidate accumulated transmit power control values responsive to a cell identification change of a serving cell for uplink transmissions via the first antenna or the second antenna.

Aspect 7: The method of any of aspects 1 through 6, wherein the adjusting the accumulated transmit power control value comprises: determining a first value that corresponds to difference between a first pathloss measurement associated with the first antenna and a second pathloss measurement associated with the second antenna; computing a second value as a product of the first value and at least one scaling factor; and adding the second value to the accumulated transmit power control value.

Aspect 8: The method of aspect 7, further comprising: resetting the pathloss discrepancy based at least in part on one or more of a receipt of two or more transmit power control commands that indicate an increase in the uplink transmit power within a time window, the accumulated transmit power control value being unchanged for a predetermined time interval in which one or more uplink communications are transmitted, or a change in a cell identification of a serving cell, wherein the time window starts upon receipt of a first transmit power control command that indicates an increase in the uplink transmit power, and the time window is reset and suspended upon expiration of the time window or receipt of a second transmit power control command that indicates a decrease in the uplink transmit power.

Aspect 9: The method of any of aspects 1 through 8, wherein the pathloss discrepancy is based at least in part on an accumulated number of transmit power control commands that indicate a decrease in the uplink transmit power.

Aspect 10: The method of aspect 9, further comprising: resetting the pathloss discrepancy based at least in part on one or more of a receipt of two or more TPC commands that indicate an increase in the uplink transmit power within a time window, the ATPC value being unchanged for a predetermined time interval in which one or more uplink communications are transmitted, or a change in a cell identification of a serving cell, wherein the time window starts upon receipt of a first TPC command that indicates an increase in the uplink transmit power, and the time window is reset and suspended upon expiration of the time window or receipt of a second TPC command that indicates the decrease in the uplink transmit power.

Aspect 11: The method of any of aspects 1 through 10, wherein the adjusting the accumulated transmit power control value is performed responsive to the pathloss discrepancy exceeding a threshold value.

Aspect 12: The method of any of aspects 1 through 11, wherein the adjusting the accumulated transmit power control value is based at least in part on a first candidate accumulated transmit power control value from a set of candidate accumulated transmit power control values that has a closest associated pathloss to an identified pathloss for the second antenna.

Aspect 13: The method of aspect 12, wherein the set of candidate accumulated transmit power control values include at least the first candidate accumulated transmit power control value associated with a first pathloss and a second candidate accumulated transmit power control value associated with a second pathloss, and wherein the method further comprises: determining that a difference between the identified pathloss for the second antenna and the first pathloss has a same value as a difference between the identified pathloss for the second antenna and the second pathloss; and selecting the first candidate accumulated transmit power control value responsive to the first candidate accumulated transmit power control value having a higher value than the second candidate accumulated transmit power control value.

Aspect 14: The method of any of aspects 12 through 13, wherein the adjusting the accumulated transmit power control value is performed responsive to the first candidate accumulated transmit power control value having a higher value than a current accumulated transmit power control value subsequent to the switch from the first antenna to the second antenna.

Aspect 15: The method of any of aspects 1 through 14, wherein the determining the pathloss discrepancy is responsive to a change in an estimated pathloss subsequent to the switch to the second antenna exceeding an amount of the adjustment in the accumulated transmit power control value.

Aspect 16: The method of aspect 15, wherein the determining the pathloss discrepancy further comprises: scaling the change in the estimated pathloss subsequent to the switch to the second antenna according to a scaling factor to determine a scaled estimated pathloss difference; and comparing the scaled estimated pathloss difference to the amount of the adjustment in the accumulated transmit power control value, and wherein the adjusting is performed responsive to the scaled estimated pathloss difference exceeding the amount of the adjustment in the accumulated transmit power control value.

Aspect 17: The method of any of aspects 1 through 16, further comprising: resetting a value associated with the pathloss discrepancy responsive to the adjusting the accumulated transmit power control value.

Aspect 18: An apparatus for wireless communications at a UE, comprising a processor; memory coupled with the processor; and instructions stored in the memory and executable by the processor to cause the apparatus to perform a method of any of aspects 1 through 17.

Aspect 19: An apparatus for wireless communications at a UE, comprising at least one means for performing a method of any of aspects 1 through 17.

Aspect 20: A non-transitory computer-readable medium storing code for wireless communications at a UE, the code comprising instructions executable by a processor to perform a method of any of aspects 1 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a user equipment (UE), comprising:
receiving one or more transmit power control commands for an uplink transmit power for an uplink transmission via at least a first antenna, the one or more transmit power control commands indicating a decrease in an uplink transmit power, wherein the uplink transmit power for the uplink transmission is based on an accumulation of a plurality of transmit power control commands;
determining, subsequent to the receiving the one or more transmit power control commands, to switch from the first antenna to a second antenna for one or more communications;
determining a pathloss discrepancy based at least in part on one or more pathloss measurements and the one or more transmit power control commands associated with the first antenna; and
adjusting, based at least in part on the pathloss discrepancy, an accumulated transmit power control value associated with a transmit power control procedure for communications via the second antenna.

2. The method of claim 1, wherein the determining the pathloss discrepancy comprises:
determining that two or more transmit power control commands that indicate a decrease in the uplink transmit power are received within a predetermined time interval.

3. The method of claim 1, wherein the adjusting the accumulated transmit power control value comprises:
selecting a first accumulated transmit power control value from a set of candidate accumulated transmit power control values based at least in part on a pathloss associated with each of the candidate accumulated transmit power control values and a pathloss associated with the second antenna; and
adjusting the accumulated transmit power control value based at least in part on the first accumulated transmit power control value.

4. The method of claim 3, further comprising:
identifying, for at least one measurement instance prior to the switch from the first antenna to a second antenna, a pathloss associated with the first antenna; and
storing an accumulated transmit power control value and the identified pathloss as a candidate accumulated transmit power control value of the set of candidate accumulated transmit power control values.

5. The method of claim 4, further comprising:
determining, subsequent to the identifying, to store the accumulated transmit power control value and the identified pathloss based at least in part on:
the associated accumulated transmit power control value being larger than a prior accumulated transmit power control value and a threshold value, or
the associated accumulated transmit power control value exceeding the threshold value and being unchanged for at least a predetermined time interval in which one or more uplink communications are transmitted.

6. The method of claim 4, further comprising:
resetting the set of candidate accumulated transmit power control values responsive to a cell identification change of a serving cell for uplink transmissions via the first antenna or the second antenna.

7. The method of claim 1, wherein the adjusting the accumulated transmit power control value comprises:
determining a first value that corresponds to difference between a first pathloss measurement associated with the first antenna and a second pathloss measurement associated with the second antenna;
computing a second value as a product of the first value and at least one scaling factor; and
adding the second value to the accumulated transmit power control value.

8. The method of claim 7, further comprising:
resetting the pathloss discrepancy based at least in part on one or more of a receipt of two or more transmit power control commands that indicate an increase in the uplink transmit power within a time window, the accumulated transmit power control value being unchanged for a predetermined time interval in which one or more uplink communications are transmitted, or a change in a cell identification of a serving cell,
wherein the time window starts upon receipt of a first transmit power control command that indicates an increase in the uplink transmit power, and the time window is reset and suspended upon expiration of the time window or receipt of a second transmit power control command that indicates a decrease in the uplink transmit power.

9. The method of claim 1, wherein the pathloss discrepancy is based at least in part on an accumulated quantity of transmit power control commands that indicate a decrease in the uplink transmit power.

10. The method of claim 9, further comprising:
resetting the pathloss discrepancy based at least in part on one or more of a receipt of two or more transmit power control commands that indicate an increase in the uplink transmit power within a time window, the accumulated transmit power control value being unchanged for a predetermined time interval in which one or more uplink communications are transmitted, or a change in a cell identification of a serving cell,
wherein the time window starts upon receipt of a first transmit power control command that indicates an increase in the uplink transmit power, and the time window is reset and suspended upon expiration of the time window or receipt of a second transmit power control command that indicates the decrease in the uplink transmit power.

11. The method of claim 1, wherein the adjusting the accumulated transmit power control value is performed responsive to the pathloss discrepancy exceeding a threshold value.

12. The method of claim 1, wherein the adjusting the accumulated transmit power control value is based at least in part on a first candidate accumulated transmit power control value from a set of candidate accumulated transmit power control values that has a closest associated pathloss to an identified pathloss for the second antenna.

13. The method of claim 12, wherein the set of candidate accumulated transmit power control values include at least the first candidate accumulated transmit power control value associated with a first pathloss and a second candidate accumulated transmit power control value associated with a second pathloss, and wherein the method further comprises:
determining that a difference between the identified pathloss for the second antenna and the first pathloss has a same value as a difference between the identified pathloss for the second antenna and the second pathloss; and
selecting the first candidate accumulated transmit power control value responsive to the first candidate accumulated transmit power control value having a higher value than the second candidate accumulated transmit power control value.

14. The method of claim 12, wherein the adjusting the accumulated transmit power control value is performed responsive to the first candidate accumulated transmit power control value having a higher value than a current accumulated transmit power control value subsequent to the switch from the first antenna to the second antenna.

15. The method of claim 1, wherein the determining the pathloss discrepancy is responsive to a change in an estimated pathloss subsequent to the switch to the second antenna exceeding an amount of the adjustment in the accumulated transmit power control value.

16. The method of claim 15, wherein the determining the pathloss discrepancy further comprises:
scaling the change in the estimated pathloss subsequent to the switch to the second antenna according to a scaling factor to determine a scaled estimated pathloss difference; and
comparing the scaled estimated pathloss difference to the amount of the adjustment in the accumulated transmit power control value, and wherein the adjusting is performed responsive to the scaled estimated pathloss difference exceeding the amount of the adjustment in the accumulated transmit power control value.

17. The method of claim 1, further comprising:
resetting a value associated with the pathloss discrepancy responsive to the adjusting the accumulated transmit power control value.

18. An apparatus for wireless communications at a user equipment (UE), comprising:
a processor;
memory coupled with the processor; and
instructions stored in the memory and executable by the processor to cause the apparatus to:
receive one or more transmit power control commands for an uplink transmit power for an uplink transmission via at least a first antenna, the one or more transmit power control commands indicating a decrease in an uplink transmit power, wherein the uplink transmit power for the uplink transmission is based on an accumulation of a plurality of transmit power control commands;
determine, subsequent to the receiving the one or more transmit power control commands, to switch from the first antenna to a second antenna for one or more communications;
determine a pathloss discrepancy based at least in part on one or more pathloss measurements and the one or more transmit power control commands associated with the first antenna; and
adjust, base at least in part on the pathloss discrepancy, an accumulated transmit power control value associated with a transmit power control procedure for communications via the second antenna.

19.-28. (canceled)

29. A non-transitory computer-readable medium storing code for wireless communications at a user equipment (UE), the code comprising instructions executable by a processor to:
receive one or more transmit power control commands for an uplink transmit power for an uplink transmission via at least a first antenna, the one or more transmit power control commands indicating a decrease in an uplink transmit power, wherein the uplink transmit power for the uplink transmission is based on an accumulation of a plurality of transmit power control commands;
determine, subsequent to the receiving the one or more transmit power control commands, to switch from the first antenna to a second antenna for one or more communications;
determine a pathloss discrepancy based at least in part on one or more pathloss measurements and the one or more transmit power control commands associated with the first antenna; and
adjust, base at least in part on the pathloss discrepancy, an accumulated transmit power control value associated with a transmit power control procedure for communications via the second antenna.

30. (canceled)
